(19) United States
(12) Patent Application Publication
(10) Pub. No.: US 2022/0020393 A1
(43) Pub. Date: Jan. 20, 2022

(54) MAGNETIC TAPE, MAGNETIC TAPE CARTRIDGE, AND MAGNETIC TAPE APPARATUS

(71) Applicant: FUJIFILM Corporation, Tokyo (JP)

(72) Inventors: Takuto KUROKAWA, Kanagawa (JP); So MATSUYAMA, Kanagawa (JP); Norihito KASADA, Kanagawa (JP)

(73) Assignee: FUJIFILM Corporation, Tokyo (JP)

(21) Appl. No.: 17/376,175

(22) Filed: Jul. 15, 2021

(30) Foreign Application Priority Data
Jul. 17, 2020 (JP) 2020-123167

(51) Int. Cl. G11B 5/706; G11B 5/735; G11B 5/714; G11B 5/592; G11B 5/73

(52) U.S. Cl. CPC G11B 5/70678; G11B 5/7356; G11B 5/73929; G11B 5/5928; G11B 5/714

(57) ABSTRACT

The magnetic tape includes a non-magnetic support and a magnetic layer including a ferromagnetic powder, in which in an environment of a temperature of 23° C. and a relative humidity of 50%, an AlFeSil abrasion value_{0.2 N} on a magnetic layer surface, which is measured by applying a tension of 0.2 N in a longitudinal direction of the magnetic tape, is in a range of 20 to 50 μm, and an AlFeSil abrasion value_{1.5 N} on the magnetic layer surface measured by applying a tension of 1.5 N in the longitudinal direction of the magnetic tape is in a range of 20 to 50 μm.

### CROSS-REFERENCE TO RELATED APPLICATIONS

This application claims priority under 35 U.S.C 119 to Japanese Patent Application No. 2020-123167 filed on Jul. 17, 2020. The above application is hereby expressly incorporated by reference, in its entirety, into the present application.

### BACKGROUND OF THE INVENTION

### 1. Field of the Invention

The present invention relates to a magnetic tape, a magnetic tape cartridge, and a magnetic tape apparatus.

### 2. Description of the Related Art

There are two types of magnetic recording media: a tape shape and a disk shape, and a tape-shaped magnetic recording medium, that is, a magnetic tape is mainly used for storage applications such as data backup and archiving (for example, see JP6590104B and JP6635216B).

### SUMMARY OF THE INVENTION

Recording of data on a magnetic tape is usually performed by running the magnetic tape in a magnetic tape apparatus (generally called a “drive”) and recording the data on a data band by making a magnetic head follow the data band of the magnetic tape. Thereby, a data track is formed in the data band. In addition, in a case where the recorded data is reproduced, the data recorded on the data band is read by running the magnetic tape in the magnetic tape apparatus and by making the magnetic head follow the data band of the magnetic tape.

In order to increase an accuracy of the magnetic head following the data band of the magnetic tape in recording and/or reproduction as described above, a system for performing head tracking using a servo signal (hereinafter, it is described as a “servo system”) has been put into practical use.

Further, dimension information in a width direction of the magnetic tape during running is acquired using the servo signal, and a tension applied in a longitudinal direction of the magnetic tape is adjusted according to the acquired dimension information, thereby controlling the dimension in the width direction of the magnetic tape (see, for example, paragraph 0170 of JP6590104B and paragraph 0117 of JP6635216B). It is considered that the above-described tension adjustment can contribute to suppression of occurrence of a phenomenon such as overwriting of recorded data and reproduction failure in a case where the magnetic head for recording or reproducing data deviates from a target track position due to width deformation of the magnetic tape during recording or reproduction. For magnetic recording, since it is required to obtain excellent electromagnetic conversion characteristics, it is desirable that deterioration of electromagnetic conversion characteristics is small in a case where the magnetic tape is run in the magnetic tape apparatus to record and/or reproduce data while performing tension adjustment as described above.

An object of an aspect of the present invention is to provide a magnetic tape having little deterioration in electromagnetic conversion characteristics in a case where recording and/or reproduction is performed by controlling a dimension in a width direction of the magnetic tape by adjusting a tension applied in a longitudinal direction of the magnetic tape.

An aspect of the present invention relates to a magnetic tape comprising a non-magnetic support and a magnetic layer including a ferromagnetic powder, in which in an environment of a temperature of 23° C. and a relative humidity of 50%, an AlFeSil abrasion value_{0.2 N} on a magnetic layer surface, which is measured by applying a tension of 0.2 N in a longitudinal direction of the magnetic tape, is in a range of 20 to 50 μm, and an AlFeSil abrasion value_{1.5 N} on the magnetic layer surface, which is measured by applying a tension of 1.5 N in the longitudinal direction of the magnetic tape, is in a range of 20 to 50 μm.

In one embodiment, the AlFeSil abrasion value_{0.2 N} may be in a range of 20 to 45 μm.

In one embodiment, the AlFeSil abrasion value_{1.5 N} may be in a range of 30 to 50 μm.

In one embodiment, the magnetic layer may include one or more non-magnetic powders.

In one embodiment, the non-magnetic powder may include an alumina powder.

In one embodiment, the magnetic tape may further comprise a non-magnetic layer including a non-magnetic powder between the non-magnetic support and the magnetic layer.

In one embodiment, the magnetic tape may further comprise a back coating layer including a non-magnetic powder on a surface side of the non-magnetic support opposite to a surface side having the magnetic layer.

In one embodiment, a tape thickness of the magnetic tape may be 5.2 μm or less.

Another aspect of the present invention relates to a magnetic tape cartridge comprising the magnetic tape described above.

Still another aspect of the present invention relates to a magnetic tape apparatus comprising the magnetic tape described above.

In one embodiment, the magnetic tape apparatus may further comprise a tension adjusting mechanism capable of adjusting the tension applied in the longitudinal direction of the magnetic tape running in the magnetic tape apparatus.

In one embodiment, the magnetic tape apparatus may further comprise a magnetic head having a reproducing element width of 0.8 μm or less.

In one embodiment, the magnetic tape may further comprise a tension adjusting mechanism capable of adjusting the tension applied in the longitudinal direction of the magnetic tape running in the magnetic tape apparatus and a magnetic head having a reproducing element width of 0.8 μm or less.

According to an aspect of the present invention, it is possible to provide a magnetic tape having little deterioration in electromagnetic conversion characteristics in a case where recording and/or reproduction is performed by controlling a dimension in a width direction of the magnetic tape by adjusting a tension applied in a longitudinal direction of the magnetic tape. In addition, according to an aspect of the present invention, it is possible to provide a magnetic tape cartridge and a magnetic tape apparatus which include the magnetic tape.

### BRIEF DESCRIPTION OF THE DRAWINGS

FIG. 1 shows an arrangement example of a data band and a servo band.

FIG. 2 shows an arrangement example of a servo pattern of a linear tape-open (LTO) Ultrium format tape.

FIG. 3 is a schematic view showing an example of a magnetic tape apparatus.

### DESCRIPTION OF THE PREFERRED EMBODIMENTS

Magnetic Tape

An aspect of the present invention relates to a magnetic tape including a non-magnetic support and a magnetic layer including a ferromagnetic powder. In an environment of a temperature of 23° C. and a relative humidity of 50%, an AlFeSil abrasion value_{0.2 N} on a magnetic layer surface, which is measured by applying a tension of 0.2 N in a longitudinal direction of the magnetic tape, is in a range of 20 to 50 μm, and an AlFeSil abrasion value_{1.5 N} on the magnetic layer surface, which is measured by applying a tension of 1.5 N in the longitudinal direction of the magnetic tape, is in a range of 20 to 50 μm. In the present invention and the present specification, the “magnetic layer surface (surface of the magnetic layer)” has the same meaning as a surface of the magnetic tape on a magnetic layer side.

In a magnetic tape apparatus that controls a dimension in a width direction of the magnetic tape by adjusting the tension applied in the longitudinal direction of the magnetic tape, the larger the tension is applied in the longitudinal direction of the magnetic tape, the larger the dimension in the width direction of the magnetic tape can be shrunk (that is, the width can be made narrower), and the smaller the tension is, the smaller the degree of the shrunk can be. By adjusting the tension applied in the longitudinal direction of the magnetic tape in this manner, the dimension in the width direction of the magnetic tape can be controlled.

On the other hand, recording of data on the magnetic tape and reproduction of the recorded data are usually performed as the magnetic layer surface of the magnetic tape and a magnetic head come into contact with each other to be slid on each other. The present inventor considers that in a case where the tension adjustment as described above is performed, the fact that the tension applied in the longitudinal direction of the magnetic tape may change may cause deterioration of electromagnetic conversion characteristics. Specifically, the present inventor supposes that in a case where a contact state between the magnetic layer surface of the magnetic tape and the magnetic head is greatly changed due to the change of the tension applied in the longitudinal direction of the magnetic tape, a degree of abrasion of the magnetic head caused by the contact with the magnetic layer surface greatly differs during recording and/or reproduction, and thereby electromagnetic conversion characteristics deteriorate.

Based on the above supposition, the present inventor has made extensive studies. As a result, regarding abrasion characteristics of the magnetic tape, it has been newly found that both the AlFeSil abrasion values (AlFeSil abrasion value_{0.2 N} and AlFeSil abrasion value_{1.5 N}), which are measured by applying different tensions in the longitudinal direction in an environment of a temperature of 23° C. and a relative humidity of 50%, are set to be in a range of 20 to 50 μm, whereby it is possible to suppress deterioration of electromagnetic conversion characteristics in a case where recording and/or reproduction is performed by controlling the dimension in the width direction of the magnetic tape by adjusting the tension applied in the longitudinal direction of the magnetic tape. The temperature and humidity of a measurement environment are employed as exemplary values of the temperature and humidity of the use environment of the magnetic tape. Therefore, an environment in which data is recorded on the magnetic tape and the recorded data is reproduced is not limited to the temperature and humidity environment. The tension applied in the longitudinal direction of the magnetic tape in a case of measuring the AlFeSil abrasion value is also employed as an exemplary value of the tension that can be applied in the longitudinal direction of the magnetic tape in a case where the tension adjustment as described above is performed. Therefore, the tension applied in the longitudinal direction of the magnetic tape in a case where data is recorded on the magnetic tape and the recorded data is reproduced is not limited to the above tension. In addition, the present invention is not limited by supposition of the present inventor described in the present specification.

In the present invention and the present specification, the AlFeSil abrasion value_{0.2 N} and the AlFeSil abrasion value_{1.5 N} are values to be measured by the following method in an environment of a temperature of 23° C. and a relative humidity of 50%.

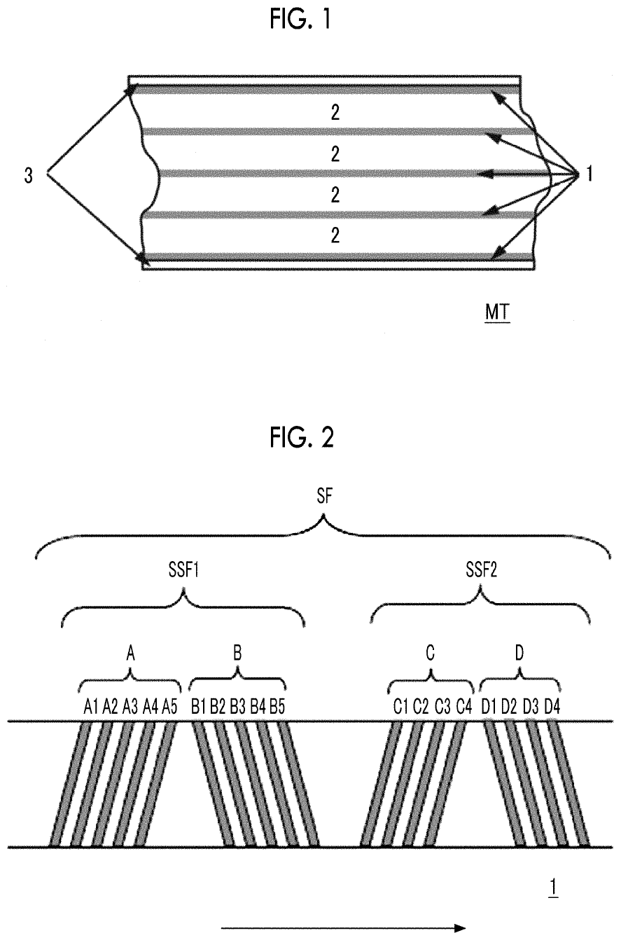

An abrasion width of an AlFeSil square bar when the magnetic tape to be measured is run under the following running conditions using a reel tester is measured. The AlFeSil square bar is a square bar made of AlFeSil, which is a Sendust-based alloy. For the evaluation, an AlFeSil square bar specified in European Computer Manufacturers Association (ECMA)-288/Annex H/H2 is used. The abrasion width of the AlFeSil square bar is obtained as an abrasion width described in a paragraph 0015 of JP2007-026564A, based on FIG. 1 of the same publication, by observing an edge of the AlFeSil square bar from above using an optical microscope.

Running Conditions The magnetic layer surface of the magnetic tape is brought into contact with one edge side of the AlFeSil square bar at a lap angle of 12° so as to be orthogonal to a longitudinal direction of the AlFeSil square bar. In this state, a portion of the magnetic tape to be measured over a length of 580 m in the longitudinal direction is run at a speed of 3 m/sec to make one reciprocation.

In the measurement of the AlFeSil abrasion value_{0.2 N}, the tension applied in the longitudinal direction of the magnetic tape during the above running is set to 0.2 N. Here, a value of the tension applied in the longitudinal direction of the magnetic tape during running is a set value of the reel tester. The AlFeSil abrasion width thus measured after one reciprocation is defined as the AlFeSil abrasion value_{0.2 N}. The AlFeSil abrasion value_{1.5 N} is obtained in the same manner as above except that the tension applied in the longitudinal direction of the magnetic tape during the running is set to 1.5 N. The measurement of the AlFeSil abrasion value_{0.2 N} and the measurement of the AlFeSil abrasion value_{1.5 N} are performed on different portions of the magnetic tape to be measured. In addition, before each measurement, the magnetic tape to be measured is left in the measurement environment for 24 hours or more in order to be adapted to the measurement environment.

AlFeSil Abrasion Value_{0.2 N} and AlFeSil abrasion Value_{1.5 N} Regarding abrasion characteristics of the magnetic tape, from the viewpoint of suppressing deterioration of electromagnetic conversion characteristics in a case where recording and/or reproduction is performed by controlling the dimension in the width direction of the magnetic tape by adjusting the tension applied in the longitudinal direction of the magnetic tape, the AlFeSil abrasion value_{0.2 N} and the AlFeSil abrasion value_{1.5 N} are both in a range of 20 to 50 μm. From the viewpoint of further suppressing deterioration of the electromagnetic conversion characteristics, the AlFeSil abrasion value_{0.2 N} is preferably 45 μm or less, more preferably 40 μm or less, and still more preferably 35 μm or less. From the same viewpoint, the AlFeSil abrasion value_{0.2 N} is preferably 23 μm or more, and more preferably 25 μm or more. In addition, from the viewpoint of further suppressing deterioration of the electromagnetic conversion characteristics, the AlFeSil abrasion value_{1.5 N} is preferably 25 μm or more, and more preferably 30 μm or more. From the same viewpoint, the AlFeSil abrasion value_{1.5 N} is preferably 48 μm or less, more preferably 45 μm or less, and still more preferably 40 μm or less. The AlFeSil abrasion value_{0.2 N} and the AlFeSil abrasion value_{1.5 N} may be the same value in an aspect and different values in another aspect. In a case where the AlFeSil abrasion value_{0.2 N} and the AlFeSil abrasion value_{1.5 N} are different values, in an aspect, the AlFeSil abrasion value_{0.2 N}<the AlFeSil abrasion value_{1.5 N} may be satisfied, and in another aspect, the AlFeSil abrasion value_{0.2 N}>the AlFeSil abrasion value_{1.5 N} may be satisfied.

The abrasion characteristics of the magnetic tape can be adjusted, for example, by the type of component used to manufacture the magnetic layer. Details of this point will be described below.

Hereinafter, the magnetic tape will be described in detail.

Magnetic Layer

Ferromagnetic Powder

As a ferromagnetic powder included in the magnetic layer, a well-known ferromagnetic powder as a ferromagnetic powder used in magnetic layers of various magnetic recording media can be used alone or in combination of two or more. From the viewpoint of improving recording density, it is preferable to use a ferromagnetic powder having a small average particle size. From this point, the average particle size of the ferromagnetic powder is preferably 50 nm or less, more preferably 45 nm or less, still more preferably 40 nm or less, still more preferably 35 nm or less, still more preferably 30 nm or less, still more preferably 25 nm or less, and still more preferably 20 nm or less. On the other hand, from the viewpoint of magnetization stability, the average particle size of the ferromagnetic powder is preferably 5 nm or more, more preferably 8 nm or more, still more preferably 10 nm or more, still more preferably 15 nm or more, and still more preferably 20 nm or more.

Hexagonal Ferrite Powder Preferred specific examples of the ferromagnetic powder include a hexagonal ferrite powder. For details of the hexagonal ferrite powder, for example, descriptions disclosed in paragraphs 0012 to 0030 of JP2011-225417A, paragraphs 0134 to 0136 of JP2011-216149A, paragraphs 0013 to 0030 of JP2012-204726A, and paragraphs 0029 to 0084 of JP2015-127985A can be referred to.

In the present invention and the present specification, the term “hexagonal ferrite powder” refers to a ferromagnetic powder in which a hexagonal ferrite type crystal structure is detected as a main phase by X-ray diffraction analysis. The main phase refers to a structure to which the highest intensity diffraction peak in an X-ray diffraction spectrum obtained by X-ray diffraction analysis is attributed. For example, in a case where the highest intensity diffraction peak is attributed to a hexagonal ferrite type crystal structure in an X-ray diffraction spectrum obtained by X-ray diffraction analysis, it is determined that the hexagonal ferrite type crystal structure is detected as the main phase. In a case where only a single structure is detected by X-ray diffraction analysis, this detected structure is taken as the main phase. The hexagonal ferrite type crystal structure includes at least an iron atom, a divalent metal atom, and an oxygen atom, as a constituent atom. The divalent metal atom is a metal atom that can be a divalent cation as an ion, and examples thereof may include an alkaline earth metal atom such as a strontium atom, a barium atom, and a calcium atom, and a lead atom. In the present invention and the present specification, a hexagonal strontium ferrite powder refers to a powder in which a main divalent metal atom is a strontium atom, and a hexagonal barium ferrite powder refers to a powder in which a main divalent metal atom is a barium atom. The main divalent metal atom refers to a divalent metal atom that accounts for the most on an at % basis among the divalent metal atoms included in the powder. Here, a rare earth atom is not included in the above divalent metal atom. The term “rare earth atom” in the present invention and the present specification is selected from the group consisting of a scandium atom (Sc), an yttrium atom (Y), and a lanthanoid atom. The Lanthanoid atom is selected from the group consisting of a lanthanum atom (La), a cerium atom (Ce), a praseodymium atom (Pr), a neodymium atom (Nd), a promethium atom (Pm), a samarium atom (Sm), a europium atom (Eu), a gadolinium atom (Gd), a terbium atom (Tb), a dysprosium atom (Dy), a holmium atom (Ho), an erbium atom (Er), a thulium atom (Tm), an ytterbium atom (Yb), and a lutetium atom (Lu).

Hereinafter, the hexagonal strontium ferrite powder, which is an aspect of the hexagonal ferrite powder, will be described in more detail.

An activation volume of the hexagonal strontium ferrite powder is preferably in a range of 800 to 1600 nm³. The finely granulated hexagonal strontium ferrite powder having an activation volume in the above range is suitable for manufacturing a magnetic tape exhibiting excellent electromagnetic conversion characteristics. The activation volume of the hexagonal strontium ferrite powder is preferably 800 nm³ or more, and may be, for example, 850 nm³ or more. Further, from the viewpoint of further improving the electromagnetic conversion characteristics, the activation volume of the hexagonal strontium ferrite powder is more preferably 1500 nm³ or less, still more preferably 1400 nm³ or less, still more preferably 1300 nm³ or less, still more preferably 1200 nm³ or less, and still more preferably 1100 nm³ or less. The same applies to an activation volume of the hexagonal barium ferrite powder.

The “activation volume” is a unit of magnetization reversal and is an index indicating the magnetic size of a particle. An activation volume described in the present invention and the present specification and an anisotropy constant Ku which will be described below are values obtained from the following relational expression between a coercivity He and an activation volume V, by performing measurement in a coercivity He measurement portion at a magnetic field sweep rate of 3 minutes and 30 minutes using a vibrating sample magnetometer (measurement temperature: 23° C.±1° C.). For a unit of the anisotropy constant Ku, 1 erg/cc=1.0×10⁻¹ J/m³.

Hc=2Ku/Ms{1−[(kT/KuV)ln(At/0.693)]^{1/2}}

[In the above expression, Ku: anisotropy constant (unit: J/m³), Ms: saturation magnetization (Unit: kA/m), k: Boltzmann constant, T: absolute temperature (unit: K), V: activation volume (unit: cm³), A: spin precession frequency (unit: s⁻¹), t: magnetic field reversal time (unit: s)]

An index for reducing thermal fluctuation, in other words, for improving thermal stability may include the anisotropy constant Ku. The hexagonal strontium ferrite powder preferably has Ku of 1.8×10⁵ J/m³ or more, and more preferably has Ku of 2.0×10⁵ J/m³ or more. Ku of the hexagonal strontium ferrite powder may be, for example, 2.5×10¹ J/m³ or less. Here, the higher Ku is, the higher the thermal stability is, which is preferable, and thus, a value thereof is not limited to the values exemplified above.

The hexagonal strontium ferrite powder may or may not include a rare earth atom. In a case where the hexagonal strontium ferrite powder includes a rare earth atom, it is preferable to include a rare earth atom at a content (bulk content) of 0.5 to 5.0 at % with respect to 100 at % of an iron atom. In an aspect, the hexagonal strontium ferrite powder including a rare earth atom may have a rare earth atom surface layer portion uneven distribution property. In the present invention and the present specification, the “rare earth atom surface layer portion uneven distribution property” means that a rare earth atom content with respect to 100 at % of an iron atom in a solution obtained by partially dissolving the hexagonal strontium ferrite powder with an acid (hereinafter, referred to as a “rare earth atom surface layer portion content” or simply a “surface layer portion content” for a rare earth atom) and a rare earth atom content with respect to 100 at % of an iron atom in a solution obtained by totally dissolving the hexagonal strontium ferrite powder with an acid (hereinafter, referred to as a “rare earth atom bulk content” or simply a “bulk content” for a rare earth atom) satisfy a ratio of a rare earth atom surface layer portion content/a rare earth atom bulk content >1.0. A rare earth atom content in the hexagonal strontium ferrite powder which will be described below has the same meaning as the rare earth atom bulk content. On the other hand, partial dissolution using an acid dissolves a surface layer portion of a particle constituting the hexagonal strontium ferrite powder, and thus, a rare earth atom content in a solution obtained by partial dissolution is a rare earth atom content in a surface layer portion of a particle constituting the hexagonal strontium ferrite powder. A rare earth atom surface layer portion content satisfying a ratio of “rare earth atom surface layer portion content/rare earth atom bulk content >1.0” means that in a particle constituting the hexagonal strontium ferrite powder, rare earth atoms are unevenly distributed in a surface layer portion (that is, more than an inside). The surface layer portion in the present invention and the present specification means a partial region from a surface of a particle constituting the hexagonal strontium ferrite powder toward an inside.

In a case where the hexagonal strontium ferrite powder includes a rare earth atom, a rare earth atom content (bulk content) is preferably in a range of 0.5 to 5.0 at % with respect to 100 at % of an iron atom. It is considered that a bulk content in the above range of the included rare earth atom and uneven distribution of the rare earth atoms in a surface layer portion of a particle constituting the hexagonal strontium ferrite powder contribute to suppression of a decrease in reproduction output during repeated reproduction. It is supposed that this is because the hexagonal strontium ferrite powder includes a rare earth atom with a bulk content in the above range, and rare earth atoms are unevenly distributed in a surface layer portion of a particle constituting the hexagonal strontium ferrite powder, and thus it is possible to increase an anisotropy constant Ku. The higher a value of an anisotropy constant Ku is, the more a phenomenon called so-called thermal fluctuation can be suppressed (in other words, thermal stability can be improved). By suppressing occurrence of thermal fluctuation, it is possible to suppress a decrease in reproduction output during repeated reproduction. It is supposed that uneven distribution of rare earth atoms in a particulate surface layer portion of the hexagonal strontium ferrite powder contributes to stabilization of spins of iron (Fe) sites in a crystal lattice of a surface layer portion, and thus, an anisotropy constant Ku may be increased.

Moreover, it is supposed that the use of the hexagonal strontium ferrite powder having a rare earth atom surface layer portion uneven distribution property as a ferromagnetic powder in the magnetic layer also contributes to inhibition of a magnetic layer surface from being scraped by being slid with respect to the magnetic head. That is, it is supposed that the hexagonal strontium ferrite powder having a rare earth atom surface layer portion uneven distribution property can also contribute to an improvement of running durability of the magnetic tape. It is supposed that this may be because uneven distribution of rare earth atoms on a surface of a particle constituting the hexagonal strontium ferrite powder contributes to an improvement of interaction between the particle surface and an organic substance (for example, a binding agent and/or an additive) included in the magnetic layer, and, as a result, a strength of the magnetic layer is improved.

From the viewpoint of suppressing a decrease in reproduction output during repeated reproduction and/or the viewpoint of further improving running durability, the rare earth atom content (bulk content) is more preferably in a range of 0.5 to 4.5 at %, still more preferably in a range of 1.0 to 4.5 at %, and still more preferably in a range of 1.5 to 4.5 at %.

The bulk content is a content obtained by totally dissolving the hexagonal strontium ferrite powder. In the present invention and the present specification, unless otherwise noted, the content of an atom means a bulk content obtained by totally dissolving the hexagonal strontium ferrite powder. The hexagonal strontium ferrite powder including a rare earth atom may include only one kind of rare earth atom as the rare earth atom, or may include two or more kinds of rare earth atoms. The bulk content in the case of including two or more types of rare earth atoms is obtained for the total of two or more types of rare earth atoms. This also applies to other components in the present invention and the present specification. That is, unless otherwise noted, a certain component may be used alone or in combination of two or more. A content amount or a content in a case where two or more components are used refers to that for the total of two or more components.

In a case where the hexagonal strontium ferrite powder includes a rare earth atom, the included rare earth atom need only be any one or more of rare earth atoms. As a rare earth atom that is preferable from the viewpoint of suppressing a decrease in reproduction output during repeated reproduction, there are a neodymium atom, a samarium atom, a yttrium atom, and a dysprosium atom, here, the neodymium atom, the samarium atom, and the yttrium atom are more preferable, and a neodymium atom is still more preferable.

In the hexagonal strontium ferrite powder having a rare earth atom surface layer portion uneven distribution property, the rare earth atoms need only be unevenly distributed in the surface layer portion of a particle constituting the hexagonal strontium ferrite powder, and the degree of uneven distribution is not limited. For example, for a hexagonal strontium ferrite powder having a rare earth atom surface layer portion uneven distribution property, a ratio of a surface layer portion content of a rare earth atom obtained by partial dissolution under dissolution conditions which will be described below to a bulk content of a rare earth atom obtained by total dissolution under dissolution conditions which will be described below, that is, “surface layer portion content/bulk content” exceeds 1.0 and may be 1.5 or more. The fact that “surface layer portion content/bulk content” is larger than 1.0 means that in a particle constituting the hexagonal strontium ferrite powder, rare earth atoms are unevenly distributed in the surface layer portion (that is, more than an inside). Further, a ratio of a surface layer portion content of a rare earth atom obtained by partial dissolution under dissolution conditions which will be described below to a bulk content of a rare earth atom obtained by total dissolution under the dissolution conditions which will be described below, that is, “surface layer portion content/bulk content” may be, for example, 10.0 or less, 9.0 or less, 8.0 or less, 7.0 or less, 6.0 or less, 5.0 or less, or 4.0 or less. Here, in the hexagonal strontium ferrite powder having a rare earth atom surface layer portion uneven distribution property, the rare earth atoms need only be unevenly distributed in the surface layer portion of a particle constituting the hexagonal strontium ferrite powder, and “surface layer portion content/bulk content” is not limited to the exemplified upper limit or lower limit.

The partial dissolution and the total dissolution of the hexagonal strontium ferrite powder will be described below. For the hexagonal strontium ferrite powder that exists as a powder, the partially and totally dissolved sample powder is taken from the same lot of powder. On the other hand, for the hexagonal strontium ferrite powder included in the magnetic layer of the magnetic tape, a part of the hexagonal strontium ferrite powder taken out from the magnetic layer is subjected to partial dissolution, and the other part is subjected to total dissolution. The hexagonal strontium ferrite powder can be taken out from the magnetic layer by a method described in a paragraph 0032 of JP2015-91747A, for example.

The partial dissolution means that dissolution is performed such that, at the end of dissolution, the residue of the hexagonal strontium ferrite powder can be visually checked in the solution. For example, by partial dissolution, it is possible to dissolve a region of 10 to 20 mass % of the particle constituting the hexagonal strontium ferrite powder with the total particle being 100 mass %. On the other hand, the total dissolution means that dissolution is performed such that, at the end of dissolution, the residue of the hexagonal strontium ferrite powder cannot be visually checked in the solution.

The partial dissolution and measurement of the surface layer portion content are performed by the following method, for example. Here, the following dissolution conditions such as the amount of sample powder are exemplified, and dissolution conditions for partial dissolution and total dissolution can be employed in any manner.

A container (for example, a beaker) containing 12 mg of the sample powder and 10 mL of 1 mol/L hydrochloric acid is held on a hot plate at a set temperature of 70° C. for 1 hour. The obtained solution is filtered by a membrane filter of 0.1 μm. Elemental analysis of the filtrated solution is performed by an inductively coupled plasma (ICP) analyzer. In this way, the surface layer portion content of a rare earth atom with respect to 100 at % of an iron atom can be obtained. In a case where a plurality of types of rare earth atoms are detected by elemental analysis, the total content of all rare earth atoms is defined as the surface layer portion content. This also applies to the measurement of the bulk content.

On the other hand, the total dissolution and measurement of the bulk content are performed by the following method, for example.

A container (for example, a beaker) containing 12 mg of the sample powder and 10 mL of 4 mol/L hydrochloric acid is held on a hot plate at a set temperature of 80° C. for 3 hours. Thereafter, the same procedure as the partial dissolution and the measurement of the surface layer portion content is carried out, and the bulk content with respect to 100 at % of an iron atom can be obtained.

From the viewpoint of increasing the reproduction output in a case of reproducing data recorded on the magnetic tape, it is desirable that mass magnetization σs of the ferromagnetic powder included in the magnetic tape is high. In this regard, the hexagonal strontium ferrite powder including a rare earth atom but not having the rare earth atom surface layer portion uneven distribution property tends to have a larger decrease in σs than that of the hexagonal strontium ferrite powder including no rare earth atom. With respect to this, it is considered that the hexagonal strontium ferrite powder having a rare earth atom surface layer portion uneven distribution property is preferable in suppressing such a large decrease in σs. In an aspect, as of the hexagonal strontium ferrite powder may be 45 A·m²/kg or more, and may be 47 A·m²/kg or more. On the other hand, from the viewpoint of noise reduction, σs is preferably 80 A·m²/kg or less and more preferably 60 A·m²/kg or less. σs can be measured using a well-known measuring device, such as a vibrating sample magnetometer, capable of measuring magnetic properties. In the present invention and the present specification, unless otherwise noted, the mass magnetization σs is a value measured at a magnetic field intensity of 15 kOe. 1 [kOe]=10⁶/4π [A/m]

Regarding the content (bulk content) of a constituent atom of the hexagonal strontium ferrite powder, a strontium atom content may be, for example, in a range of 2.0 to 15.0 at % with respect to 100 at % of an iron atom. In an aspect, the hexagonal strontium ferrite powder may include only a strontium atom as a divalent metal atom. In another aspect, the hexagonal strontium ferrite powder may include one or more other divalent metal atoms in addition to a strontium atom. For example, a barium atom and/or a calcium atom may be included. In a case where divalent metal atoms other than a strontium atom are included, a barium atom content and a calcium atom content in the hexagonal strontium ferrite powder are, for example, in a range of 0.05 to 5.0 at % with respect to 100 at % of an iron atom.

As a crystal structure of hexagonal ferrite, a magnetoplumbite type (also referred to as an “M type”), a W type, a Y type, and a Z type are known. The hexagonal strontium ferrite powder may have any crystal structure. The crystal structure can be checked by X-ray diffraction analysis. In the hexagonal strontium ferrite powder, a single crystal structure or two or more crystal structures may be detected by X-ray diffraction analysis. For example, according to an aspect, in the hexagonal strontium ferrite powder, only the M-type crystal structure may be detected by X-ray diffraction analysis. For example, M-type hexagonal ferrite is represented by a composition formula of AFe₁₂O₁₉. Here, A represents a divalent metal atom, and in a case where the hexagonal strontium ferrite powder is the M-type, A is only a strontium atom (Sr), or in a case where, as A, a plurality of divalent metal atoms are included, as described above, a strontium atom (Sr) accounts for the most on an at % basis.

The divalent metal atom content of the hexagonal strontium ferrite powder is usually determined by the type of crystal structure of the hexagonal ferrite and is not particularly limited. The same applies to the iron atom content and the oxygen atom content. The hexagonal strontium ferrite powder may include at least an iron atom, a strontium atom, and an oxygen atom, and may further include a rare earth atom. Furthermore, the hexagonal strontium ferrite powder may or may not include atoms other than these atoms. As an example, the hexagonal strontium ferrite powder may include an aluminum atom (Al). A content of an aluminum atom may be, for example, 0.5 to 10.0 at % with respect to 100 at % of an iron atom. From the viewpoint of suppressing a decrease in reproduction output during repeated reproduction, the hexagonal strontium ferrite powder includes an iron atom, a strontium atom, an oxygen atom, and a rare earth atom, and the content of atoms other than these atoms is preferably 10.0 at % or less, more preferably in a range of 0 to 5.0 at %, and may be 0 at % with respect to 100 at % of an iron atom. That is, in an aspect, the hexagonal strontium ferrite powder may not include atoms other than an iron atom, a strontium atom, an oxygen atom, and a rare earth atom. The content expressed in at % is obtained by converting a content of each atom (unit: mass %) obtained by totally dissolving the hexagonal strontium ferrite powder into a value expressed in at % using an atomic weight of each atom. Further, in the present invention and the present specification, the term “not include” for a certain atom means that a content measured by an ICP analyzer after total dissolution is 0 mass %. A detection limit of the ICP analyzer is usually 0.01 parts per million (ppm) or less on a mass basis. The term “not included” is used as a meaning including that an atom is included in an amount less than the detection limit of the ICP analyzer. In an aspect, the hexagonal strontium ferrite powder may not include a bismuth atom (Bi).

Metal Powder Preferred specific examples of the ferromagnetic powder include a ferromagnetic metal powder. For details of the ferromagnetic metal powder, for example, descriptions disclosed in paragraphs 0137 to 0141 of JP2011-216149A and paragraphs 0009 to 0023 of JP2005-251351A can be referred to.

ε-Iron Oxide Powder

Preferred specific examples of the ferromagnetic powder include an ε-iron oxide powder. In the present invention and the present specification, the term “ε-iron oxide powder” refers to a ferromagnetic powder in which an ε-iron oxide type crystal structure is detected as a main phase by X-ray diffraction analysis. For example, in a case where the highest intensity diffraction peak is attributed to an ε-iron oxide type crystal structure in an X-ray diffraction spectrum obtained by X-ray diffraction analysis, it is determined that the ε-iron oxide type crystal structure is detected as the main phase. As a method of manufacturing the ε-iron oxide powder, a producing method from a goethite, a reverse micelle method, and the like are known. All of the manufacturing methods are well known. Regarding a method of manufacturing an ε-iron oxide powder in which a part of Fe is substituted with substitutional atoms such as Ga, Co, Ti, Al, or Rh, a description disclosed in J. Jpn. Soc. Powder Metallurgy Vol. 61 Supplement, No. S1, pp. S280 to S284, J. Mater. Chem. C, 2013, 1, pp. 5200 to 5206 can be referred to, for example. Here, the method of manufacturing the ε-iron oxide powder capable of being used as the ferromagnetic powder in the magnetic layer of the magnetic tape is not limited to the methods described here.

An activation volume of the ε-iron oxide powder is preferably in a range of 300 to 1500 nm³. The finely granulated ε-iron oxide powder having an activation volume in the above range is suitable for manufacturing a magnetic tape exhibiting excellent electromagnetic conversion characteristics. The activation volume of the ε-iron oxide powder is preferably 300 nm³ or more, and may be, for example, 500 nm³ or more. Further, from the viewpoint of further improving the electromagnetic conversion characteristics, the activation volume of the ε-iron oxide powder is more preferably 1400 nm³ or less, still more preferably 1300 nm³ or less, still more preferably 1200 nm³ or less, and still more preferably 1100 nm³ or less.

An index for reducing thermal fluctuation, in other words, for improving thermal stability may include the anisotropy constant Ku. The ε-iron oxide powder preferably has Ku of 3.0×10° J/m³ or more, and more preferably has Ku of 8.0×10° J/m³ or more. Ku of the ε-iron oxide powder may be, for example, 3.0×10⁵ J/m³ or less. Here, the higher Ku is, the higher the thermal stability is, which is preferable, and thus, a value thereof is not limited to the values exemplified above.

From the viewpoint of increasing the reproduction output in a case of reproducing data recorded on the magnetic tape, it is desirable that mass magnetization σs of the ferromagnetic powder included in the magnetic tape is high. In this regard, in an aspect, as of the ε-iron oxide powder may be 8 A·m²/kg or more, and may be 12 A·m²/kg or more. On the other hand, from the viewpoint of noise reduction, as of the ε-iron oxide powder is preferably 40 A·m²/kg or less and more preferably 35 A·m²/kg or less.

In the present invention and the present specification, unless otherwise noted, an average particle size of various powders such as ferromagnetic powders is a value measured by the following method using a transmission electron microscope.

The powder is imaged at an imaging magnification of 100000 using a transmission electron microscope, and the image is printed on printing paper so that the total magnification is 500000 to obtain an image of particles constituting the powder. A target particle is selected from the obtained image of particles, an outline of the particle is traced by a digitizer, and a size of the particle (primary particle) is measured. The primary particle is an independent particle which is not aggregated.

The measurement described above is performed regarding 500 particles randomly extracted. An arithmetic average of the particle sizes of 500 particles thus obtained is an average particle size of the powder. As the transmission electron microscope, a transmission electron microscope H-9000 manufactured by Hitachi, Ltd. can be used, for example. In addition, the measurement of the particle size can be performed by well-known image analysis software, for example, image analysis software KS-400 manufactured by Carl Zeiss. An average particle size shown in Examples which will be described below is a value measured by using a transmission electron microscope H-9000 manufactured by Hitachi, Ltd. as the transmission electron microscope, and image analysis software KS-400 manufactured by Carl Zeiss as the image analysis software, unless otherwise noted. In the present invention and the present specification, the powder means an aggregate of a plurality of particles. For example, the ferromagnetic powder means an aggregate of a plurality of ferromagnetic particles. Further, the aggregate of the plurality of particles not only includes an aspect in which particles constituting the aggregate directly come into contact with each other, but also includes an aspect in which a binding agent or an additive which will be described below is interposed between the particles. The term “particle” is used to describe a powder in some cases.

As a method of taking a sample powder from the magnetic tape in order to measure the particle size, a method disclosed in a paragraph 0015 of JP2011-048878A can be used, for example.

In the present invention and the present specification, unless otherwise noted, (1) in a case where the shape of the particle observed in the particle image described above is a needle shape, a fusiform shape, or a columnar shape (here, a height is greater than a maximum long diameter of a bottom surface), the size (particle size) of the particles constituting the powder is shown as a length of a long axis configuring the particle, that is, a long axis length, (2) in a case where the shape of the particle is a plate shape or a columnar shape (here, a thickness or a height is smaller than a maximum long diameter of a plate surface or a bottom surface), the particle size is shown as a maximum long diameter of the plate surface or the bottom surface, and (3) in a case where the shape of the particle is a sphere shape, a polyhedron shape, or an amorphous shape, and the long axis configuring the particles cannot be specified from the shape, the particle size is shown as an equivalent circle diameter. The equivalent circle diameter is a value obtained by a circle projection method.

In addition, regarding an average acicular ratio of the powder, a length of a short axis, that is, a short axis length of the particles is measured in the measurement described above, a value of (long axis length/short axis length) of each particle is obtained, and an arithmetic average of the values obtained regarding 500 particles is calculated. Here, unless otherwise noted, in a case of (1), the short axis length as the definition of the particle size is a length of a short axis configuring the particle, in a case of (2), the short axis length is a thickness or a height, and in a case of (3), the long axis and the short axis are not distinguished, thus, the value of (long axis length/short axis length) is assumed as 1, for convenience.

In addition, unless otherwise noted, in a case where the shape of the particle is specified, for example, in a case of definition of the particle size (1), the average particle size is an average long axis length, and in a case of the definition (2), the average particle size is an average plate diameter. In a case of the definition (3), the average particle size is an average diameter (also referred to as an average particle diameter).

The content (filling percentage) of the ferromagnetic powder of the magnetic layer is preferably in a range of 50 to 90 mass % and more preferably in a range of 60 to 90 mass %. A high filling percentage of the ferromagnetic powder in the magnetic layer is preferable from the viewpoint of improvement of recording density.

Binding Agent

The magnetic tape can be a coating type magnetic tape, and include a binding agent in the magnetic layer. The binding agent is one or more resins. As the binding agent, various resins usually used as a binding agent of a coating type magnetic recording medium can be used. For example, as the binding agent, a resin selected from a polyurethane resin, a polyester resin, a polyamide resin, a vinyl chloride resin, an acrylic resin obtained by copolymerizing styrene, acrylonitrile, or methyl methacrylate, a cellulose resin such as nitrocellulose, an epoxy resin, a phenoxy resin, and a polyvinylalkylal resin such as polyvinyl acetal or polyvinyl butyral can be used alone or a plurality of resins can be mixed with each other to be used. Among these, a polyurethane resin, an acrylic resin, a cellulose resin, and a vinyl chloride resin are preferable. These resins may be homopolymers or copolymers. These resins can be used as the binding agent even in a non-magnetic layer and/or a back coating layer which will be described below. For the above binding agent, descriptions disclosed in paragraphs 0028 to 0031 of JP2010-24113A can be referred to. In addition, the binding agent may be a radiation curable resin such as an electron beam curable resin. For the radiation curable resin, descriptions disclosed in paragraphs 0044 and 0045 of JP2011-048878A can be referred to.

An average molecular weight of the resin used as the binding agent may be, for example, 10,000 or more and 200,000 or less as a weight-average molecular weight. The binding agent may be used in an amount of, for example, 1.0 to 30.0 parts by mass with respect to 100.0 parts by mass of the ferromagnetic powder.

Curing Agent

A curing agent can also be used together with the binding agent. As the curing agent, in an aspect, a thermosetting compound which is a compound in which a curing reaction (crosslinking reaction) is progressed due to heating can be used, and in another aspect, a photocurable compound in which a curing reaction (crosslinking reaction) is progressed due to light irradiation can be used. At least a part of the curing agent can be included in the magnetic layer in a state of being reacted (crosslinked) with other components such as the binding agent by progressing a curing reaction in a process of manufacturing the magnetic tape. The preferred curing agent is a thermosetting compound, and polyisocyanate is suitable for this. For details of the polyisocyanate, descriptions disclosed in paragraphs 0124 and 0125 of JP2011-216149A can be referred to. The curing agent can be used in a magnetic layer forming composition in an amount of, for example, 0 to 80.0 parts by mass, and preferably 50.0 to 80.0 parts by mass from the viewpoint of improving a strength of each layer such as the magnetic layer, with respect to 100.0 parts by mass of the binding agent.

Additive

The magnetic layer may include one or more kinds of additives, as necessary. As the additives, the curing agent described above is used as an example. In addition, examples of the additive which can be included in the magnetic layer include non-magnetic powder, a lubricant, a dispersing agent, a dispersing assistant, a fungicide, an antistatic agent, and an antioxidant.

Examples of the dispersing agent that can be added to the magnetic layer forming composition include a well-known dispersing agent for improving the dispersibility of the ferromagnetic powder such as a carboxy group-containing compound and a nitrogen-containing compound. For example, the nitrogen-containing compound may be any of a primary amine represented by NH₂R, a secondary amine represented by NHR₂, and a tertiary amine represented by NR₃. In the above, R represents any structure constituting the nitrogen-containing compound, and a plurality of R's may be the same as or different from each other. The nitrogen-containing compound may be a compound (polymer) having a plurality of repeating structures in the molecule. It is considered that a nitrogen-containing portion of the nitrogen-containing compound functions as an adsorbing portion on the particle surface of the ferromagnetic powder, which is the reason why the nitrogen-containing compound can function as a dispersing agent. Examples of the carboxy group-containing compound include a fatty acid such as oleic acid. It is considered that a carboxy group of the carboxy group-containing compound functions as an adsorbing portion on the particle surface of the ferromagnetic powder, which is the reason why the carboxy group-containing compound can function as a dispersing agent. It is also preferable to use the carboxy group-containing compound and the nitrogen-containing compound in combination. The amount of these dispersing agents used can be set appropriately.

The dispersing agent may be added to a non-magnetic layer forming composition. For the dispersing agent that can be added to the non-magnetic layer forming composition, a description disclosed in a paragraph 0061 of JP2012-133837A can be referred to.

Examples of the additive that can be added to the magnetic layer include a polyalkyleneimine polymer disclosed in JP2016-51493A. For such a polyalkyleneimine polymer, descriptions disclosed in paragraphs 0035 to 0077 of JP2016-51493A and Examples of the same publication can be referred to.

Examples of the non-magnetic powder that can be included in the magnetic layer include a non-magnetic powder which can function as an abrasive and a non-magnetic powder which can function as a protrusion forming agent which forms protrusions suitably protruded from the magnetic layer surface.

As the abrasive, a non-magnetic powder having a Mohs hardness of more than 8 is preferable, and a non-magnetic powder having a Mohs hardness of 9 or more is more preferable. A maximum value of a Mohs hardness is 10. The abrasive can be a powder of an inorganic substance and can also be a powder of an organic substance. The abrasive can be an inorganic or organic oxide powder or a carbide powder. Examples of the carbide include boron carbide (for example, B₄C) and titanium carbide (for example, TiC). Diamond can also be used as the abrasive. In an aspect, the abrasive is preferably an inorganic oxide powder. Specifically, examples of the inorganic oxide include alumina (for example, Al₂O₃), titanium oxide (for example, TiO₂), cerium oxide (for example, CeO₂), and zirconium oxide (for example, ZrO₂), among these, alumina is preferable. A Mohs hardness of alumina is about 9. For the alumina powder, a description disclosed in a paragraph 0021 of JP2013-229090A can be referred to. A specific surface area can be used as an index of the particle size of the abrasive. It can be considered that the larger the specific surface area, the smaller the particle size of the primary particles of particles constituting the abrasive. As the abrasive, it is preferable to use an abrasive having a specific surface area (hereinafter, referred to as a “BET specific surface area”) measured by a Brunauer-Emmett-Teller (BET) method of 14 m²/g or more. Further, from the viewpoint of the dispersibility, it is preferable to use an abrasive having a BET specific surface area of 40 m²/g or less. A content of the abrasive in the magnetic layer is preferably 1.0 to 20.0 parts by mass, and more preferably 1.0 to 15.0 parts by mass, with respect to 100.0 parts by mass of the ferromagnetic powder. As the abrasive, only one kind of non-magnetic powder can be used, and two or more kinds of non-magnetic powders having different compositions and/or physical properties (for example, size) can also be used. In a case where two or more kinds of non-magnetic powders are used as the abrasive, the content of the abrasive means the total content of the two or more kinds of non-magnetic powders. The same applies to contents of various components in the present invention and the present specification. The abrasive is preferably subjected to a dispersion treatment separately from the ferromagnetic powder (separate dispersion), and more preferably subjected to a dispersion treatment separately from the protrusion forming agent described below (separate dispersion). In a case where the magnetic layer forming composition is prepared, it is preferable to prepare two or more kinds of dispersion liquids having different components and/or dispersion conditions as a dispersion liquid of the abrasive (hereinafter, referred to as an “abrasive liquid”) in order to control the abrasion characteristics of the magnetic tape.

A dispersing agent can also be used for adjusting the dispersion state of the dispersion liquid of the abrasive. Examples of a compound that can function as a dispersing agent for improving the dispersibility of the abrasive include an aromatic hydrocarbon compound having a phenolic hydroxy group. The “phenolic hydroxy group” refers to a hydroxy group directly bonded to an aromatic ring. The aromatic ring included in the aromatic hydrocarbon compound may be a monocyclic ring, a polycyclic structure, or a fused ring. From the viewpoint of improving the dispersibility of the abrasive, an aromatic hydrocarbon compound including a benzene ring or a naphthalene ring is preferable. Further, the aromatic hydrocarbon compound may have a substituent other than the phenolic hydroxy group. Examples of the substituent other than the phenolic hydroxy group include a halogen atom, an alkyl group, an alkoxy group, an amino group, an acyl group, a nitro group, a nitroso group, and a hydroxyalkyl group, and a halogen atom, an alkyl group, an alkoxy group, an amino group, and a hydroxyalkyl group are preferable. The number of phenolic hydroxy groups included in one molecule of the aromatic hydrocarbon compound may be one, two, three, or more.

As a preferable aspect of the aromatic hydrocarbon compound having the phenolic hydroxy group, a compound represented by Formula 100 can be exemplified.

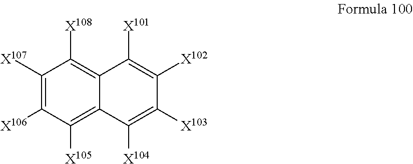

[In Formula 100, two of X¹⁰¹ to X¹⁰⁸ are hydroxy groups, and the other six independently represent a hydrogen atom or a substituent.]

In the compound represented by Formula 100, the substitution positions of two hydroxy groups (phenolic hydroxy groups) are not particularly limited.

In Formula 100, two of X¹⁰¹ to X¹⁰⁸ are hydroxy groups (phenolic hydroxy groups), and the other six independently represent a hydrogen atom or a substituent. Further, in X¹⁰¹ to X¹⁰⁸, moieties other than the two hydroxy groups may all be hydrogen atoms, or some or all of them may be substituents. As a substituent, the substituent described above can be exemplified. As a substituent other than the two hydroxy groups, one or more phenolic hydroxy groups may be included. From the viewpoint of improving the dispersibility of the abrasive, it is preferable that the phenolic hydroxy group is not used except for the two hydroxy groups of X¹⁰¹ to X¹⁰⁸. That is, the compound represented by Formula 100 is preferably dihydroxynaphthalene or a derivative thereof, and more preferably 2,3-dihydroxynaphthalene or a derivative thereof. Examples of preferred substituents represented by X¹⁰¹ to X¹⁰⁸ include a halogen atom (for example, a chlorine atom or a bromine atom), an amino group, an alkyl group having 1 to 6 carbon atoms (preferably 1 to 4), a methoxy group and an ethoxy group, an acyl group, a nitro group and a nitroso group, and —CH₂OH group.

For the dispersing agent for improving the dispersibility of the abrasive, descriptions disclosed in paragraphs 0024 to 0028 of JP2014-179149A can be referred to.

The dispersing agent for improving the dispersibility of the abrasive can be used, for example, in a proportion of 0.5 to 20.0 parts by mass, and is preferably used in a proportion of 1.0 to 10.0 parts by mass to 100.0 parts by mass of the abrasive, for example, in a case where the abrasive liquid is prepared (for each abrasive liquid in a case where a plurality of the abrasive liquids are prepared).

As an aspect of the protrusion forming agent, carbon black can be exemplified. A BET specific surface area of carbon black is preferably 10 m²/g or more, and more preferably 15 m²/g or more. The BET specific surface area of carbon black is preferably 50 m²/g or less, and more preferably 40 m²/g or less, from the viewpoint of the ease of improving the dispersibility. In addition, as another aspect of the protrusion forming agent, colloidal particles can be exemplified. The colloidal particles are preferably inorganic colloidal particles, more preferably inorganic oxide colloidal particles, and still more preferably silica colloidal particles (colloidal silica), from the viewpoint of availability. In the present invention and the present specification, the “colloidal particles” refer to particles which are dispersed without precipitation to generate a colloidal dispersion, in a case where 1 g of the particles is added to 100 mL of at least one organic solvent of methyl ethyl ketone, cyclohexanone, toluene, or ethyl acetate, or a mixed solvent including two or more kinds of the solvent described above at an optional mixing ratio. An average particle size of the colloidal particles can be, for example, 30 to 300 nm, and preferably 40 to 200 nm. A content of the protrusion forming agent in the magnetic layer is preferably 0.5 to 4.0 parts by mass, and more preferably 0.5 to 3.5 parts by mass, with respect to 100.0 parts by mass of the ferromagnetic powder. The protrusion forming agent is preferably subjected to a dispersion treatment separately from the ferromagnetic powder, and more preferably subjected to a dispersion treatment separately from the abrasive. In a case where the magnetic layer forming composition is prepared, two or more kinds of dispersion liquids having different components and/or dispersion conditions can be prepared as a dispersion liquid of the protrusion forming agent (hereinafter, referred to as a “protrusion forming agent liquid”).

As an aspect of the additive that may be included in the magnetic layer, a compound having an ammonium salt structure of an alkyl ester anion represented by Formula 1 can be exemplified.

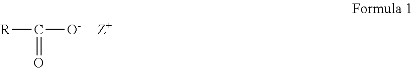

(In Formula 1, R represents an alkyl group having 7 or more carbon atoms or a fluorinated alkyl group having 7 or more carbon atoms, and Z⁺ represents an ammonium cation.)

The present inventor considers that the above compound can function as a lubricant. This point will be further described below.

The lubricant can be broadly divided into a fluid lubricant and a boundary lubricant. The present inventor considers that the compound having the ammonium salt structure of the alkyl ester anion represented by Formula 1 can function as a fluid lubricant. It is considered that the fluid lubricant itself can play a role of imparting lubricity to the magnetic layer by forming a liquid film on the magnetic layer surface. It is supposed that it is desirable that the fluid lubricant forms a liquid film on the magnetic layer surface, in order to control the AlFeSil abrasion value_{0.2 N} and the AlFeSil abrasion value_{1.5 N}. In addition, in a case where the AlFeSil abrasion value_{0.2 N} and the AlFeSil abrasion value_{1.5 N} are measured, the measured value may be smaller as the magnetic layer surface and the AlFeSil square bar can be slid on each other more stably. Regarding the liquid film of the fluid lubricant, it is considered desirable to use an appropriate amount of the fluid lubricant forming the liquid film on the magnetic layer surface, from the viewpoint of enabling more stable sliding. This is because it is supposed that in a case where the amount of the liquid lubricant forming the liquid film on the magnetic layer surface is excessive, the magnetic layer surface and the AlFeSil square bar are adhered to each other and sliding stability is likely to be lowered. In addition, it is supposed that in a case where the amount of the liquid lubricant forming the liquid film on the magnetic layer surface is excessive, the protrusion formed on the magnetic layer surface by, for example, a protrusion forming agent is covered with the liquid film. It is considered that this can also be a factor that makes the sliding stability be lowered.

Regarding the above point, the above compound includes the ammonium salt structure of the alkyl ester anion represented by Formula 1. It is considered that a compound including such a structure can play an excellent role as a fluid lubricant even in a relatively small amount. Therefore, it is considered that the inclusion of the above compound in the magnetic layer leads to improvement of the sliding stability between the magnetic layer surface of the magnetic tape and the AlFeSil square bar, and can contribute to controlling of the AlFeSil abrasion value_{0.2 N} and the AlFeSil abrasion value_{1.5 N}.

Hereinafter, the above compound will be described in more detail.

In the present invention and the present specification, unless otherwise noted, groups described below may have a substituent or may be unsubstituted. In addition, for a group having a substituent, the term “carbon atoms” means the number of carbon atoms not including the number of carbon atoms of the substituent, unless otherwise noted. In the present invention and the present specification, examples of the substituent include an alkyl group (for example, an alkyl group having 1 to 6 carbon atoms), a hydroxy group, an alkoxy group (for example, an alkoxy group having 1 to 6 carbon atoms), a halogen atom (for example, a fluorine atom, a chlorine atom, a bromine atom, or the like), a cyano group, an amino group, a nitro group, an acyl group, a carboxy group, a salt of a carboxy group, a sulfonic acid group, and a salt of a sulfonic acid group.

In the compound having the ammonium salt structure of the alkyl ester anion represented by Formula 1, at least a part included in the magnetic layer can form a liquid film on the magnetic layer surface, and a part included in the magnetic layer can move to the magnetic layer surface during sliding with the magnetic head to form a liquid film. In addition, a part of the compound can be included in the non-magnetic layer described below, and can move to the magnetic layer and further move to the magnetic layer surface to form a liquid film. The “alkyl ester anion” can also be called an “alkyl carboxylate anion”.

In Formula 1, R represents an alkyl group having 7 or more carbon atoms or a fluorinated alkyl group having 7 or more carbon atoms. The fluorinated alkyl group has a structure in which some or all of the hydrogen atoms constituting the alkyl group are substituted with fluorine atoms. The alkyl group or the fluorinated alkyl group represented by R may have a linear structure or a branched structure, may be a cyclic alkyl group or a fluorinated alkyl group, and is preferably a linear structure. The alkyl group or the fluorinated alkyl group represented by R may have a substituent, may be unsubstituted, and is preferably unsubstituted. The alkyl group represented by R can be represented by, for example, CₙH₂ₙ₊₁₋. Here, n represents an integer of 7 or more. In addition, the fluorinated alkyl group represented by R may have a structure in which some or all of the hydrogen atoms constituting the alkyl group represented by, for example, CₙH₂ₙ₊₁₋ are substituted with fluorine atoms. The carbon number of the alkyl group or the fluorinated alkyl group represented by R is 7 or more, preferably 8 or more, more preferably 9 or more, still more preferably 10 or more, still more preferably 11 or more, still more preferably 12 or more, and still more preferably 13 or more. In addition, the carbon number of the alkyl group or the fluorinated alkyl group represented by R is preferably 20 or less, more preferably 19 or less, and still more preferably 18 or less.

In Formula 1, Z⁺ represents an ammonium cation. Specifically, the ammonium cation has the following structure. In the present invention and the present specification, “*” in the formula representing a part of a compound represents a bonding position between a structure of the part and an adjacent atom.

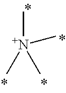

A nitrogen cation N⁺ of the ammonium cation and an oxygen anion O⁻ in Formula 1 may form a salt crosslinking group to form the ammonium salt structure of the alkyl ester anion represented by Formula 1. The inclusion of the compound having the ammonium salt structure of the alkyl ester anion represented by Formula 1 in the magnetic layer can be confirmed by analyzing the magnetic tape by X-ray photoelectron spectroscopy (electron spectroscopy for chemical analysis (ESCA)), infrared spectroscopy (IR), or the like.

In an aspect, the ammonium cation represented by Z⁺ may be provided, for example, by a nitrogen atom of a nitrogen-containing polymer becoming a cation. The nitrogen-containing polymer means a polymer including a nitrogen atom. In the present invention and the present specification, the term “polymer” is used to encompass a homopolymer and a copolymer. The nitrogen atom may be included as an atom constituting a main chain of the polymer in an aspect, and may be included as an atom constituting a side chain of the polymer in an aspect.

As an aspect of the nitrogen-containing polymer, polyalkyleneimine can be exemplified. Polyalkyleneimine is a ring-opening polymer of alkyleneimine and is a polymer having a plurality of repeating units represented by Formula 2.

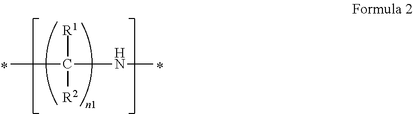

A nitrogen atom N constituting a main chain in Formula 2 is a nitrogen cation N⁺ to provide the ammonium cation represented by Z⁺ in Formula 1. Then, the ammonium salt structure can be formed with the alkyl ester anion, for example, as follows.

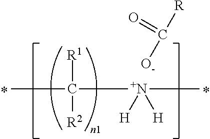

Hereinafter, Formula 2 will be described in more detail.

In Formula 2, R¹ and R² each independently represent a hydrogen atom or an alkyl group, and n1 represents an integer of 2 or more.

Examples of the alkyl group represented by R¹ or R² include an alkyl group having 1 to 6 carbon atoms, preferably an alkyl group having 1 to 3 carbon atoms, more preferably a methyl group or an ethyl group, and still more preferably a methyl group. The alkyl group represented by R¹ or R² is preferably an unsubstituted alkyl group. The combination of R¹ and R² in Formula 2 may be a form in which one is a hydrogen atom and the other is an alkyl group, a form in which both are hydrogen atoms, and a form in which both are alkyl groups (the same or different alkyl groups), and the form in which both are hydrogen atoms is preferable. As the alkyleneimine that provides the polyalkyleneimine, a structure having the lowest number of carbon atoms constituting a ring is ethyleneimine, and the number of carbon atoms in a main chain of the alkyleneimine (ethyleneimine) obtained by the ring opening of the ethyleneimine is 2. Therefore, n1 in Formula 2 is 2 or more. n1 in Formula 2 may be, for example, 10 or less, 8 or less, 6 or less, or 4 or less. The polyalkyleneimine may be a homopolymer including only the same structure as the repeating structure represented by Formula 2, or may be a copolymer including two or more different structures as the repeating structure represented by Formula 2. A number-average molecular weight of polyalkyleneimine that can be used to form the compound having the ammonium salt structure of the alkyl ester anion represented by Formula 1 may be, for example, 200 or more, preferably 300 or more, and more preferably 400 or more. The number-average molecular weight of the polyalkyleneimine may be, for example, 10,000 or less, preferably 5,000 or less, and more preferably 2,000 or less.

In the present invention and the present specification, the average molecular weight (weight-average molecular weight and number-average molecular weight) means a value measured by gel permeation chromatography (GPC) with standard polystyrene conversion. Unless otherwise noted, the average molecular weight shown in Examples described below is a value (polystyrene conversion value) obtained by standard polystyrene conversion of values measured under the following measurement conditions using GPC.

GPC device: HLC-8220 (manufactured by Tosoh Corporation)

Guard column: TSKguardcolumn Super HZM-H

Column: TSKgel Super HZ 2000, TSKgel Super HZ 4000, TSKgel Super HZ-M (manufactured by Tosoh Corporation, 4.6 mm (inner diameter)×15.0 cm, three columns connected in series)

Eluent: Tetrahydrofuran (THF), containing stabilizer (2,6-di-t-butyl-4-methylphenol)

Flow rate of eluent: 0.35 mL/min

Column temperature: 40° C.

Inlet temperature: 40° C.

Refractive index (RI) measurement temperature: 40° C.

Sample concentration: 0.3 mass %

Sample injection amount: 10 μL

As another aspect of the nitrogen-containing polymer, polyallylamine can be exemplified. Polyallylamine is a polymer of allylamine and is a polymer having a plurality of repeating units represented by Formula 3.

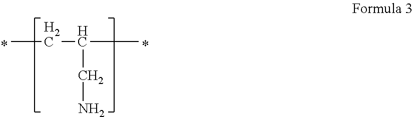

A nitrogen atom N constituting an amino group of a side chain in Formula 3 is a nitrogen cation N⁺ to provide the ammonium cation represented by Z⁺ in Formula 1. Then, the ammonium salt structure can be formed with the alkyl ester anion, for example, as follows.

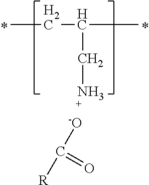

A weight-average molecular weight of polyallylamine that can be used to form the compound having the ammonium salt structure of the alkyl ester anion represented by Formula 1 may be, for example, 200 or more, preferably 1,000 or more, and more preferably 1,500 or more. The weight-average molecular weight of the polyallylamine may be, for example, 15,000 or less, preferably 10,000 or less, and more preferably 8,000 or less.

The inclusion of a compound having a structure derived from polyalkyleneimine or polyallylamine as the compound having the ammonium salt structure of the alkyl ester anion represented by Formula 1 can be confirmed by analyzing the magnetic layer surface by time-of-flight secondary ion mass spectrometry (TOF-SIMS) or the like.

The compound having the ammonium salt structure of the alkyl ester anion represented by Formula 1 may be a salt of the nitrogen-containing polymer and one or more kinds of fatty acids selected from the group consisting of fatty acids having 7 or more carbon atoms and fluorinated fatty acids having 7 or more carbon atoms. The nitrogen-containing polymer forming a salt may be one or more kinds of nitrogen-containing polymers, and may be, for example, a nitrogen-containing polymer selected from the group consisting of polyalkyleneimine and polyallylamine. The fatty acids forming a salt may be one or more kinds of fatty acids selected from the group consisting of fatty acids having 7 or more carbon atoms and fluorinated fatty acids having 7 or more carbon atoms. The fluorinated fatty acid has a structure in which some or all of the hydrogen atoms constituting an alkyl group bonded to a carboxy group COOH in the fatty acid are substituted with fluorine atoms. For example, the salt forming reaction can easily proceed by mixing the nitrogen-containing polymer and the above fatty acids at a room temperature. A room temperature is, for example, about 20° C. to 25° C. In an aspect, one or more kinds of nitrogen-containing polymers and one or more kinds of fatty acids are used as components of the magnetic layer forming composition, and these are mixed in a process of preparing the magnetic layer forming composition to allow the salt forming reaction to proceed. In addition, in an aspect, the magnetic layer forming composition can be prepared by mixing one or more kinds of nitrogen-containing polymers and one or more kinds of fatty acids to form a salt before preparation of the magnetic layer forming composition, and then using the salt as a component of the magnetic layer forming composition. This point also applies to a case of forming a non-magnetic layer including the compound having the ammonium salt structure of the alkyl ester anion represented by Formula 1. For example, for the magnetic layer, 0.1 to 10.0 parts by mass of the nitrogen-containing polymer can be used, and 0.5 to 8.0 parts by mass of the nitrogen-containing polymer is preferably used, per 100.0 parts by mass of the ferromagnetic powder. The above fatty acids can be used, for example, in an amount of 0.05 to 10.0 parts by mass and are preferably used in an amount of 0.1 to 5.0 parts by mass, per 100.0 parts by mass of the ferromagnetic powder. In addition, for the non-magnetic layer, 0.1 to 10.0 parts by mass of the nitrogen-containing polymer can be used, and 0.5 to 8.0 parts by mass of the nitrogen-containing polymer is preferably used, per 100.0 parts by mass of the non-magnetic powder. The above fatty acids can be used, for example, in an amount of 0.05 to 10.0 parts by mass and are preferably used in an amount of 0.1 to 5.0 parts by mass, per 100.0 parts by mass of the non-magnetic powder. In a case where the nitrogen-containing polymer and the fatty acids are mixed to form an ammonium salt of the alkyl ester anion represented by Formula 1, a nitrogen atom constituting the nitrogen-containing polymer may react with a carboxy group of the fatty acids to form the following structure, and a form including such a structure is also included in the compound.

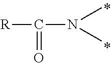

Examples of the fatty acids include fatty acids having an alkyl group described above as R in Formula 1 and fluorinated fatty acids having a fluorinated alkyl group described above as R in Formula 1.

A mixing ratio of the nitrogen-containing polymer used to form the compound having the ammonium salt structure of the alkyl ester anion represented by Formula 1 to the fatty acid is preferably 10:90 to 90:10, more preferably 20:80 to 85:15, and still more preferably 30:70 to 80:20 as a mass ratio of the nitrogen-containing polymer:the fatty acids. In addition, the compound having the ammonium salt structure of the alkyl ester anion represented by Formula 1 is preferably included in the magnetic layer in an amount of 0.01 parts by mass or more, more preferably 0.1 parts by mass or more, and still more preferably 0.5 parts by mass or more with respect to 100.0 parts by mass of the ferromagnetic powder. Here, the content of the compound in the magnetic layer means the total amount of the amount of the liquid film formed on the magnetic layer surface and the amount included inside the magnetic layer. On the other hand, a high content of the ferromagnetic powder in the magnetic layer is preferable from the viewpoint of high-density recording. Therefore, from the viewpoint of high-density recording, it is preferable that the content of components other than the ferromagnetic powder is small. From this viewpoint, the content of the compound in the magnetic layer is preferably 15.0 parts by mass or less, more preferably 10.0 parts by mass or less, and still more preferably 8.0 parts by mass or less with respect to 100.0 parts by mass of the ferromagnetic powder. In addition, the preferred range of the content of the compound in the magnetic layer forming composition used for forming the magnetic layer is also the same.

As the lubricant, for example, a fatty acid amide that can function as a boundary lubricant can be used. It is considered that the boundary lubricant is a lubricant that can reduce contact friction by adsorbing on a surface of a powder (for example, a ferromagnetic powder) and forming a rigid lubricating film. Examples of the fatty acid amide include amides of various fatty acids such as lauric acid, myristic acid, palmitic acid, stearic acid, oleic acid, linoleic acid, linolenic acid, behenic acid, erucic acid, and elaidic acid, and specifically, lauric acid amide, myristic acid amide, palmitic acid amide, and stearic acid amide. The content amount of the fatty acid amide in the magnetic layer is, for example, 0 to 3.0 parts by mass, preferably 0 to 2.0 parts by mass, and more preferably 0 to 1.0 part by mass per 100.0 parts by mass of the ferromagnetic powder. In addition, the fatty acid amide may also be included in the non-magnetic layer. The content of the fatty acid amide in the non-magnetic layer is, for example, 0 to 3.0 parts by mass, and preferably 0 to 1.0 part by mass per 100.0 parts by mass of the non-magnetic powder. For the dispersing agent, descriptions disclosed in paragraphs 0061 and 0071 of JP2012-133837A can be referred to. The dispersing agent may be added to a non-magnetic layer forming composition. For the dispersing agent that can be added to the non-magnetic layer forming composition, a description disclosed in a paragraph 0061 of JP2012-133837A can be referred to.

Regarding the suppression of deterioration of the electromagnetic conversion characteristics in a case where recording and/or reproduction is performed by controlling the dimension in the width direction of the magnetic tape by adjusting the tension applied in a longitudinal direction of the magnetic tape, the present inventor considers as follows.

It is supposed that in a case where the tension applied in the longitudinal direction of the magnetic tape may change, a degree of abrasion of the magnetic tape head caused by the contact with the magnetic tape head greatly differs during recording and/or reproduction (large variation in the degree of abrasion). It is considered that the large variation in the degree of abrasion is a factor of the deterioration of the electromagnetic conversion characteristics.

By the way, it is considered that the size and content of the abrasive, the shear stress on the magnetic head (which may affect the friction characteristics), the normal force, and the like affect the abrasion. It is considered that in a case where the tension applied in the longitudinal direction of the magnetic tape increases, the normal force tends to increase, and therefore the abrasive penetrates into the magnetic head deeply, resulting in increased friction and increased abrasion. With respect to this, it is considered that the use of the above compound, which is considered to function as a liquid lubricant, for example, as a component of the magnetic layer, leads to enhancement of the lubricity (slidability) of the magnetic layer surface, and can contribute to suppression of the large variation in the degree of abrasion of the magnetic head due to the change in tension. In addition, for the abrasive, it is supposed that the larger the amount of the abrasive included in the magnetic layer, the more likely the abrasion of the magnetic head occurs in a case where the tension applied in the longitudinal direction of the magnetic tape is high. It is supposed that in a case where the tension applied in the longitudinal direction of the magnetic tape is low, larger sized abrasives in a plurality of abrasives of different sizes used as components of the magnetic layer are more likely to cause abrasion of the magnetic head.

Regarding the above point, the present inventor considers that, for example, the use of the above compound as a component used as a lubricant for forming the magnetic layer, the combination of the abrasives used, and/or the adjustment of the content of the abrasive can contribute to controlling of the values of the AlFeSil abrasion value_{0.2 N} and the AlFeSil abrasion value_{1.5 N}. It is supposed that controlling the values of the AlFeSil abrasion value_{0.2 N} and the AlFeSil abrasion value_{1.5 N} in the ranges described above leads to suppression of deterioration of the electromagnetic conversion characteristics in a case where recording and/or reproduction is performed by controlling the dimension in the width direction of the magnetic tape by adjusting the tension applied in the longitudinal direction of the magnetic tape.

Non-Magnetic Layer

Next, the non-magnetic layer will be described. The above magnetic tape may have a magnetic layer directly on the non-magnetic support, or may have a non-magnetic layer including a non-magnetic powder between the non-magnetic support and the magnetic layer. The non-magnetic powder used for the non-magnetic layer may be an inorganic substance powder (inorganic powder) or an organic substance powder (organic powder). In addition, carbon black and the like can be used. Examples of the inorganic substance include metal, metal oxide, metal carbonate, metal sulfate, metal nitride, metal carbide, and metal sulfide.

The non-magnetic powder can be purchased as a commercially available product or can be manufactured by a well-known method. For details thereof, descriptions disclosed in paragraphs 0146 to 0150 of JP2011-216149A can be referred to. For carbon black which can be used in the non-magnetic layer, descriptions disclosed in paragraphs 0040 and 0041 of JP2010-24113A can be referred to. The content (filling percentage) of the non-magnetic powder of the non-magnetic layer is preferably in a range of 50 to 90 mass % and more preferably in a range of 60 to 90 mass %.

The non-magnetic layer can include a binding agent, and can also include an additive. For other details of the binding agent or the additive of the non-magnetic layer, a well-known technology regarding the non-magnetic layer can be applied. In addition, in regards to the type and the content of the binding agent, and the type and the content of the additive, for example, a well-known technology regarding the magnetic layer can be applied.

The non-magnetic layer of the magnetic tape also includes a substantially non-magnetic layer including a small amount of ferromagnetic powder as impurities, for example, or intentionally, together with the non-magnetic powder. Here, the substantially non-magnetic layer refers to a layer having a residual magnetic flux density of 10 mT or less, a coercivity of 7.96 kA/m (100 Oe) or less, or a residual magnetic flux density of 10 mT or less and a coercivity of 7.96 kA/m (100 Oe) or less. It is preferable that the non-magnetic layer does not have a residual magnetic flux density and a coercivity.

Non-Magnetic Support

Next, the non-magnetic support will be described. Examples of the non-magnetic support (hereinafter, simply referred to as a “support”) include well-known components such as polyethylene terephthalate, polyethylene naphthalate, polyamide, polyamideimide, and aromatic polyamide subjected to biaxial stretching. Among these, polyethylene terephthalate, polyethylene naphthalate, and polyamide are preferable. These supports may be subjected to a corona discharge, a plasma treatment, an easy-bonding treatment, or a heat treatment in advance.

Back Coating Layer

The tape may or may not have a back coating layer including a non-magnetic powder on a surface side of the non-magnetic support opposite to a surface side having the magnetic layer. The back coating layer preferably includes one or both of carbon black and inorganic powder. The back coating layer can include a binding agent, and can also include an additive. For details of the non-magnetic powder, the binding agent, and the additive of the back coating layer, a well-known technology regarding the back coating layer can be applied, and a well-known technology regarding the magnetic layer and/or the non-magnetic layer can be applied. For example, for the back coating layer, descriptions disclosed in paragraphs 0018 to 0020 of JP2006-331625A and column 4, line 65 to column 5, line 38 of U.S. Pat. No. 7,029,774B can be referred to.

Various Thicknesses

Regarding a thickness (total thickness) of the magnetic tape, it has been required to increase the recording capacity (increase the capacity) of the magnetic tape with the enormous increase in the amount of information in recent years. For example, as means for increasing the capacity, a thickness of the magnetic tape may be reduced to increase a length of the magnetic tape accommodated in one roll of a magnetic tape cartridge. From this point, the thickness (total thickness) of the magnetic tape is preferably 5.6 μm or less, more preferably 5.5 μm or less, still more preferably 5.4 μm or less, still more preferably 5.3 μm or less, and still more preferably 5.2 μm or less. In addition, from the viewpoint of ease of handling, the thickness of the magnetic tape is preferably 3.0 μm or more, and more preferably 3.5 μm or more.

The thickness (total thickness) of the magnetic tape can be measured by the following method.

Ten tape samples (for example, 5 to 10 cm in length) are cut out from any part of the magnetic tape, and these tape samples are stacked to measure the thickness. A value (thickness per tape sample) obtained by dividing the measured thickness by 1/10 is defined as the tape thickness. The thickness measurement can be performed using a well-known measuring device capable of measuring the thickness on the order of 0.1 μm.

A thickness of the non-magnetic support is preferably 3.0 to 5.0 μm.

A thickness of the magnetic layer can be optimized according to a saturation magnetization amount, a head gap length, and a band of a recording signal of the used magnetic head, and is generally 0.01 μm to 0.15 μm, and from the viewpoint of high-density recording, is preferably 0.02 μm to 0.12 μm, and more preferably 0.03 μm to 0.1 μm. The magnetic layer need only be at least a single layer, the magnetic layer may be separated into two or more layers having different magnetic properties, and a configuration of a well-known multilayered magnetic layer can be applied as the magnetic layer. A thickness of the magnetic layer in a case where the magnetic layer is separated into two or more layers is a total thickness of the layers.

A thickness of the non-magnetic layer is, for example, 0.1 to 1.5 μm, and preferably 0.1 to 1.0 μm.

A thickness of the back coating layer is preferably 0.9 μm or less, and more preferably 0.1 to 0.7 μm.

Various thicknesses such as the thickness of the magnetic layer can be obtained by the following method.

A cross section of the magnetic tape in a thickness direction is exposed by an ion beam, and then the exposed cross section observation is performed using a scanning electron microscope or a transmission electron microscope. Various thicknesses can be obtained as an arithmetic average of thicknesses obtained at two optional points in the cross section observation. Alternatively, the various thicknesses can be obtained as a designed thickness calculated according to manufacturing conditions.

Manufacturing Method

Preparation of Each Layer Forming Composition

A composition for forming the magnetic layer, the non-magnetic layer, or the back coating layer usually includes a solvent together with the various components described above. As a solvent, various organic solvents generally used for manufacturing a coating type magnetic recording medium can be used. Among these, from the viewpoint of solubility of the binding agent usually used in the coating type magnetic recording medium, each layer forming composition preferably includes one or more ketone solvents such as acetone, methyl ethyl ketone, methyl isobutyl ketone, diisobutyl ketone, cyclohexanone, isophorone, and tetrahydrofuran. The amount of the solvent in each layer forming composition is not particularly limited, and can be set to the same as that of each layer forming composition of a typical coating type magnetic recording medium. In addition, a process of preparing each layer forming composition can generally include at least a kneading process, a dispersing process, and a mixing process provided before and after these processes as necessary. Each process may be divided into two or more stages. Components used for the preparation of each layer forming composition may be added at an initial stage or in a middle stage of each process. In addition, each component may be separately added in two or more processes. For example, a binding agent may be added separately in a kneading process, a dispersing process, and a mixing process for adjusting a viscosity after dispersion. In addition, as described above, one or more kinds of nitrogen-containing polymers and one or more kinds of the fatty acids are used as the components of the magnetic layer forming composition, and these are mixed in a process of preparing the magnetic layer forming composition to allow the salt forming reaction to proceed. In addition, in an aspect, the magnetic layer forming composition can be prepared by mixing one or more kinds of nitrogen-containing polymers and one or more kinds of fatty acids to form a salt before preparation of the magnetic layer forming composition, and then using the salt as a component of the magnetic layer forming composition. This point also applies to a process of preparing the non-magnetic layer forming composition. It is preferable that the abrasive liquid is prepared by being separately dispersed from the ferromagnetic powder and the protrusion forming agent. The abrasive liquid is preferably prepared as one or more kinds of abrasive liquids including an abrasive, a solvent, and preferably a binding agent, separately from the ferromagnetic powder and the protrusion forming agent, and can be used for preparing a magnetic layer forming composition. A dispersion treatment and/or a classification treatment can be performed for the preparation of the abrasive liquid. A commercially available device can be used for these treatments.

In a process of manufacturing the magnetic tape, a well-known manufacturing technology in a related art can be used in a part or all of the processes. In the kneading process, an open kneader, a continuous kneader, a pressure kneader, or a kneader having a strong kneading force such as an extruder is preferably used. Details of the kneading treatment are described in JP1989-106338A (JP-H01-106338A) and JP1989-79274A (JP-H01-79274A). In addition, in order to disperse each layer forming composition, glass beads and/or other beads can be used. As such dispersion beads, zirconia beads, titania beads, and steel beads which are dispersion beads having a high specific gravity are suitable. These dispersion beads are preferably used by optimizing a particle diameter (bead diameter) and filling percentage. As a dispersing device, a well-known dispersing device can be used. Each layer forming composition may be filtered by a well-known method before being subjected to a coating process. The filtering can be performed by using a filter, for example. As the filter used in the filtering, a filter having a pore diameter of 0.01 to 3 μm (for example, filter made of glass fiber or filter made of polypropylene) can be used, for example.

Regarding the dispersion treatment of the magnetic layer forming composition, in an aspect, the dispersion treatment of the ferromagnetic powder is performed by the two-stage dispersion treatment, in which the coarse aggregation of the ferromagnetic powder is crushed by the first-stage dispersion treatment, and then the second-stage dispersion treatment can be performed in which the collision energy applied to the particles of the ferromagnetic powder by the collision with the dispersion beads is smaller than that in the first-stage dispersion treatment. It is considered that such a dispersion treatment makes it possible to improve the dispersibility of the ferromagnetic powder and suppress the occurrence of chipping (partially lacking particles).

An example of the two-stage dispersion treatment includes a dispersion treatment including a first stage of obtaining a dispersion liquid by subjecting a ferromagnetic powder, a binding agent, and a solvent to a dispersion treatment in the presence of first dispersion beads and a second stage of subjecting the dispersion liquid obtained in the first stage to a dispersion treatment in the presence of second dispersion beads having a smaller bead diameter and density than the first dispersion beads. Hereinafter, the above dispersion treatment will be further described.

In order to improve the dispersibility of the ferromagnetic powder, it is preferable that the first stage and the second stage described above are performed as a dispersion treatment before mixing the ferromagnetic powder with other powder components. For example, the first stage and the second stage are preferably performed as a dispersion treatment of a liquid (magnetic liquid) including a ferromagnetic powder, a binding agent, a solvent, and an optionally added additive before mixing the ferromagnetic powder with the abrasive and the protrusion forming agent.

The bead diameter of the second dispersion beads is preferably 1/100 or less of the bead diameter of the first dispersion beads, and more preferably 1/500 or less of the bead diameter of the first dispersion beads. In addition, the bead diameter of the second dispersion beads may be, for example, 1/10,000 or more of the bead diameter of the first dispersion beads. However, it is not limited to this range. For example, the bead diameter of the second dispersion beads is preferably in a range of 80 to 1,000 nm. On the other hand, the bead diameter of the first dispersion beads may be, for example, in a range of 0.2 to 1.0 mm.

In the present invention and the present specification, the bead diameter is a value measured by the same method as a method for measuring an average particle size of the powder described above.

The second stage is preferably performed under a condition that, on a mass basis, the second dispersion beads are present in an amount of 10 times or more of a ferromagnetic hexagonal ferrite powder, and more preferably performed under a condition that the second dispersion beads are present in an amount of 10 times to 30 times of the ferromagnetic hexagonal ferrite powder.

On the other hand, the amount of the first dispersion beads in the first stage is also preferably in the above range.

The second dispersion beads are beads having a density lower than that of the first dispersion beads. The “density” is obtained by dividing the mass (unit: g) of the dispersion beads by the volume (unit: cm³). The measurement is performed by an Archimedes method. The density of the second dispersion beads is preferably 3.7 g/cm³ or less, and more preferably 3.5 g/cm³ or less. The density of the second dispersion beads may be, for example, 2.0 g/cm³ or more, and may be lower than 2.0 g/cm³. Preferred second dispersion beads in terms of the density include diamond beads, silicon carbide beads, silicon nitride beads and the like, and preferred second dispersion beads in terms of the density and the hardness include diamond beads.

On the other hand, as the first dispersion beads, dispersion beads having a density of more than 3.7 g/cm³ are preferable, dispersion beads having a density of 3.8 g/cm³ or more are more preferable, and dispersion beads having a density of 4.0 g/cm³ or more are still more preferable. The density of the first dispersion beads may be, for example, 7.0 g/cm³ or less, and may be more than 7.0 g/cm³. As the first dispersion beads, zirconia beads, alumina beads, and the like are preferably used, and zirconia beads are more preferably used.

The dispersion time is not particularly limited and need only be set according to the type of the dispersing device used.

Coating Process

The magnetic layer can be formed by directly applying the magnetic layer forming composition onto the surface of the non-magnetic support or performing multilayer applying of the magnetic layer forming composition with the non-magnetic layer forming composition in order or at the same time. The back coating layer can be formed by applying the back coating layer forming composition onto a surface of the non-magnetic support opposite to a surface having the non-magnetic layer and/or the magnetic layer (or to be provided with the non-magnetic layer and/or the magnetic layer). For details of coating for forming each layer, a description disclosed in a paragraph 0066 of JP2010-231843A can be referred to.

Other Processes

Well-known technologies can be applied to other various processes for manufacturing the magnetic tape. For the various processes, for example, descriptions disclosed in paragraphs 0067 to 0070 of JP2010-231843A can be referred to. For example, a coating layer of the magnetic layer forming composition can be subjected to an orientation treatment in an orientation zone while the coating layer is in a wet state. For the orientation treatment, the various well-known technologies including a description disclosed in a paragraph 0052 of JP2010-24113A can be applied. For example, a vertical orientation treatment can be performed by a well-known method such as a method using a polar opposing magnet. In the orientation zone, a drying speed of the coating layer can be controlled depending on a temperature of dry air and an air volume and/or a transportation speed in the orientation zone. Further, the coating layer may be preliminarily dried before the transportation to the orientation zone. As an example, a magnetic field intensity in the vertical orientation treatment may be 0.1 to 1.5 T.

Through various processes, a long magnetic tape original roll can be obtained. The obtained magnetic tape original roll is cut (slit) by a well-known cutter to have a width of the magnetic tape to be accommodated in the magnetic tape cartridge. The width can be determined according to the standard, and is usually ½ inches. 1 inch=2.54 cm.

A servo pattern is usually formed on the magnetic tape obtained by slitting.

Formation of Servo Pattern

The “formation of servo pattern” can also be referred to as “recording of servo signal”. Hereinafter, the formation of the servo pattern will be described.

The servo pattern is usually formed along the longitudinal direction of the magnetic tape. Examples of control (servo control) types using a servo signal include a timing-based servo (TBS), an amplitude servo, and a frequency servo.

As shown in a European computer manufacturers association (ECMA)-319 (June 2001), a magnetic tape (generally called “LTO tape”) conforming to a linear tape-open (LTO) standard employs a timing-based servo system. In this timing-based servo system, the servo pattern is formed by continuously disposing a plurality of pairs of non-parallel magnetic stripes (also referred to as “servo stripes”) in the longitudinal direction of the magnetic tape.

In the present invention and the present specification, a “timing-based servo pattern” refers to a servo pattern that enables head tracking in a timing-based servo system. As described above, the reason why the servo pattern is formed of a pair of non-parallel magnetic stripes is to indicate, to a servo signal reading element passing over the servo pattern, a passing position thereof. Specifically, the pair of magnetic stripes is formed so that an interval thereof continuously changes along a width direction of the magnetic tape, and the servo signal reading element reads the interval to thereby sense a relative position between the servo pattern and the servo signal reading element. Information on this relative position enables tracking on a data track. Therefore, a plurality of servo tracks are usually set on the servo pattern along a width direction of the magnetic tape.

A servo band is formed of a servo pattern continuous in the longitudinal direction of the magnetic tape. A plurality of the servo bands are usually provided on the magnetic tape. For example, in an LTO tape, the number of the servo bands is five. Regions interposed between two adjacent servo bands are data bands. The data band is formed of a plurality of data tracks, and each data track corresponds to each servo track.

Further, in an aspect, as shown in JP2004-318983A, information indicating a servo band number (referred to as “servo band identification (ID)” or “unique data band identification method (UDIM) information”) is embedded in each servo band. This servo band ID is recorded by shifting a specific one of the plurality of pairs of the servo stripes in the servo band so that positions thereof are relatively displaced in the longitudinal direction of the magnetic tape. Specifically, a way of shifting the specific one of the plurality of pairs of servo stripes is changed for each servo band. Accordingly, the recorded servo band ID is unique for each servo band, and thus, the servo band can be uniquely specified only by reading one servo band with a servo signal reading element.

As a method for uniquely specifying the servo band, there is a method using a staggered method as shown in ECMA-319 (June 2001). In this staggered method, a group of pairs of non-parallel magnetic stripes (servo stripes) disposed continuously in plural in the longitudinal direction of the magnetic tape is recorded so as to be shifted in the longitudinal direction of the magnetic tape for each servo band. Since this combination of shifting methods between adjacent servo bands is unique throughout the magnetic tape, it is possible to uniquely specify a servo band in a case of reading a servo pattern with two servo signal reading elements.

As shown in ECMA-319 (June 2001), information indicating a position of the magnetic tape in the longitudinal direction (also referred to as “longitudinal position (LPOS) information”) is usually embedded in each servo band. This LPOS information is also recorded by shifting the positions of the pair of servo stripes in the longitudinal direction of the magnetic tape, as the UDIM information. Here, unlike the UDIM information, in this LPOS information, the same signal is recorded in each servo band.

It is also possible to embed, in the servo band, the other information different from the above UDIM information and LPOS information. In this case, the embedded information may be different for each servo band as the UDIM information or may be common to all servo bands as the LPOS information.

As a method of embedding information in the servo band, it is possible to employ a method other than the above. For example, a predetermined code may be recorded by thinning out a predetermined pair from the group of pairs of servo stripes.

Ahead for forming a servo pattern is called a servo write head. The servo write head usually has a pair of gaps corresponding to the pair of magnetic stripes as many as the number of servo bands. Usually, a core and a coil are connected to each pair of gaps, and by supplying a current pulse to the coil, a magnetic field generated in the core can cause generation of a leakage magnetic field in the pair of gaps. In a case of forming the servo pattern, by inputting a current pulse while running the magnetic tape on the servo write head, the magnetic pattern corresponding to the pair of gaps is transferred to the magnetic tape to form the servo pattern. A width of each gap can be appropriately set according to a density of the servo pattern to be formed. The width of each gap can be set to, for example, 1 μm or less, 1 to 10 μm, 10 μm or more, and the like.

Before the servo pattern is formed on the magnetic tape, the magnetic tape is usually subjected to a demagnetization (erasing) treatment. This erasing treatment can be performed by applying a uniform magnetic field to the magnetic tape using a direct current magnet or an alternating current magnet. The erasing treatment includes direct current (DC) erasing and alternating current (AC) erasing. AC erasing is performed by gradually decreasing an intensity of the magnetic field while reversing a direction of the magnetic field applied to the magnetic tape. On the other hand, DC erasing is performed by applying a unidirectional magnetic field to the magnetic tape. As the DC erasing, there are two methods. A first method is horizontal DC erasing of applying a unidirectional magnetic field along a longitudinal direction of the magnetic tape. A second method is vertical DC erasing of applying a unidirectional magnetic field along a thickness direction of the magnetic tape. The erasing treatment may be performed on the entire magnetic tape or may be performed for each servo band of the magnetic tape.

A direction of the magnetic field of the servo pattern to be formed is determined according to a direction of the erasing. For example, in a case where the horizontal DC erasing is performed to the magnetic tape, the servo pattern is formed so that the direction of the magnetic field is opposite to the direction of the erasing. Therefore, an output of a servo signal obtained by reading the servo pattern can be increased. As shown in JP2012-53940A, in a case where a magnetic pattern is transferred to, using the gap, a magnetic tape that has been subjected to vertical DC erasing, a servo signal obtained by reading the formed servo pattern has a monopolar pulse shape. On the other hand, in a case where a magnetic pattern is transferred to, using the gap, a magnetic tape that has been subjected to horizontal DC erasing, a servo signal obtained by reading the formed servo pattern has a bipolar pulse shape.

Magnetic Tape Cartridge

Another aspect of the present invention relates to a magnetic tape cartridge including the magnetic tape described above.

The details of the magnetic tape included in the above magnetic tape cartridge are as described above.

In the magnetic tape cartridge, generally, the magnetic tape is accommodated inside a cartridge body in a state of being wound around a reel. The reel is rotatably provided inside the cartridge body. As the magnetic tape cartridge, a single reel type magnetic tape cartridge having one reel inside the cartridge body and a dual reel type magnetic tape cartridge having two reels inside the cartridge body are widely used. In a case where the single reel type magnetic tape cartridge is mounted on a magnetic tape apparatus for recording and/or reproducing data on the magnetic tape, the magnetic tape is pulled out of the magnetic tape cartridge to be wound around the reel on the magnetic tape apparatus side. A magnetic head is disposed on a magnetic tape transportation path from the magnetic tape cartridge to a winding reel. Feeding and winding of the magnetic tape are performed between a reel (supply reel) on the magnetic tape cartridge side and a reel (winding reel) on the magnetic tape apparatus side. During this time, data is recorded and/or reproduced as the magnetic head and the magnetic layer surface of the magnetic tape come into contact with each other to be slid on each other. With respect to this, in the dual reel type magnetic tape cartridge, both reels of the supply reel and the winding reel are provided in the magnetic tape cartridge.

The magnetic tape cartridge may include a cartridge memory in an aspect. The cartridge memory may be, for example, a non-volatile memory, and may be a memory in which tension adjustment information has already been recorded or a memory in which tension adjustment information is recorded. The tension adjustment information is information for adjusting the tension applied in the longitudinal direction of the magnetic tape. Regarding the cartridge memory, the description below can also be referred to.

The magnetic tape and the magnetic tape cartridge can be suitably used in the magnetic tape apparatus (in other words, a magnetic recording and reproducing system) that controls the dimension in the width direction of the magnetic tape by adjusting the tension applied in the longitudinal direction of the magnetic tape.

Magnetic Tape Apparatus

Still another aspect of the present invention relates to a magnetic tape apparatus including the magnetic tape described above. In the magnetic tape apparatus, recording of data on the magnetic tape and/or reproduction of data recorded on the magnetic tape can be performed as the magnetic layer surface of the magnetic tape and the magnetic head come into contact with each other to be slid on each other. The magnetic tape apparatus can attachably and detachably include the magnetic tape cartridge according to an aspect of the present invention.

The magnetic tape cartridge can be mounted on the magnetic tape apparatus comprising the magnetic head and used for recording and/or reproducing data. In the present invention and the present specification, the term “magnetic tape apparatus” means an apparatus capable of performing at least one of the recording of data on the magnetic tape or the reproduction of data recorded on the magnetic tape. Such an apparatus is generally called a drive. The magnetic head included in the magnetic tape apparatus can be a recording head capable of performing the recording of data on the magnetic tape, or can be a reproducing head capable of performing the reproduction of data recorded on the magnetic tape. In addition, in an aspect, the magnetic tape apparatus can include both a recording head and a reproducing head as separate magnetic heads. In another aspect, the magnetic head included in the magnetic tape apparatus may have a configuration in which both a recording element and a reproducing element are provided in one magnetic head. As the reproducing head, a magnetic head (MR head) including a magnetoresistive (MR) element capable of sensitively reading information recorded on the magnetic tape as a reproducing element is preferable. As the MR head, various well-known MR heads (for example, a giant magnetoresistive (GMR) head and a tunnel magnetoresistive (TMR) head) can be used. In addition, the magnetic head which performs the recording of data and/or the reproduction of data may include a servo signal reading element. Alternatively, as a head other than the magnetic head which performs the recording of data and/or the reproduction of data, a magnetic head (servo head) comprising a servo signal reading element may be included in the magnetic tape apparatus. For example, a magnetic head that records data and/or reproduces recorded data (hereinafter also referred to as “recording and reproducing head”) can include two servo signal reading elements, and the two servo signal reading elements can simultaneously read two adjacent servo bands with the data band interposed therebetween. One or a plurality of elements for data can be disposed between the two servo signal reading elements. An element for recording data (recording element) and an element for reproducing data (reproducing element) are collectively referred to as an “element for data”.

By reproducing data using a reproducing element having a narrow reproducing element width as a reproducing element, data recorded at high-density can be reproduced with high sensitivity. From this viewpoint, the reproducing element width of the reproducing element is preferably 0.8 μm or less. The reproducing element width of the reproducing element may be, for example, 0.3 μm or more. Note that it is also preferable to be lower than this value from the above viewpoint.

On the other hand, as the reproducing element width becomes narrower, a phenomenon such as reproduction failure due to off-track is more likely to occur. In order to suppress occurrence of such a phenomenon, the magnetic tape apparatus that controls the dimension in the width direction of the magnetic tape by adjusting the tension applied in the longitudinal direction of the magnetic tape is preferable.

Here, the term “reproducing element width” means a physical dimension of the reproducing element width. Such a physical dimension can be measured by an optical microscope, a scanning electron microscope, or the like.

In a case of recording data and/or reproducing recorded data, first, tracking using the servo signal can be performed. That is, by causing the servo signal reading element to follow a predetermined servo track, the element for data can be controlled to pass on the target data track. Displacement of the data track is performed by changing a servo track read by the servo signal reading element in a tape width direction.

The recording and reproducing head can also perform recording and/or reproduction with respect to other data bands. In this case, the servo signal reading element need only be displaced to a predetermined servo band using the above described UDIM information to start tracking for the servo band.

FIG. 1 shows an arrangement example of the data band and the servo band. In FIG. 1, in the magnetic layer of a magnetic tape MT, a plurality of servo bands 1 are arranged so as to be interposed between guide bands 3. A plurality of regions 2 interposed between two servo bands are data bands. The servo pattern is a magnetization region, and is formed by magnetizing a specific region of the magnetic layer by the servo write head. A region magnetized by the servo write head (a position where the servo pattern is formed) is determined by the standard. For example, in an LTO Ultrium format tape which is based on a local standard, a plurality of servo patterns inclined with respect to a tape width direction as shown in FIG. 2 are formed on a servo band, in a case of manufacturing a magnetic tape. Specifically, in FIG. 2, a servo frame SF on the servo band 1 is composed of a servo sub-frame 1 (SSF1) and a servo sub-frame 2 (SSF2). The servo sub-frame 1 is composed of an A burst (in FIG. 2, reference numeral A) and a B burst (in FIG. 2, reference numeral B). The A burst is composed of servo patterns A1 to A5 and the B burst is composed of servo patterns B1 to B5. Meanwhile, the servo sub-frame 2 is composed of a C burst (in FIG. 2, reference numeral C) and a D burst (in FIG. 2, reference numeral D). The C burst is composed of servo patterns CI to C4 and the D burst is composed of servo patterns D1 to D4. Such 18 servo patterns are arranged in the sub-frames in an array of 5, 5, 4, 4, as the sets of 5 servo patterns and 4 servo patterns, and are used for identifying the servo frames. FIG. 2 shows one servo frame for description. In practice, however, a plurality of the servo frames are arranged in the running direction in each servo band in the magnetic layer of the magnetic tape on which the head tracking of the timing-based servo system is performed. In FIG. 2, an arrow shows a running direction. For example, an LTO Ultrium format tape usually has 5000 or more servo frames per 1 m of tape length in each servo band of the magnetic layer.

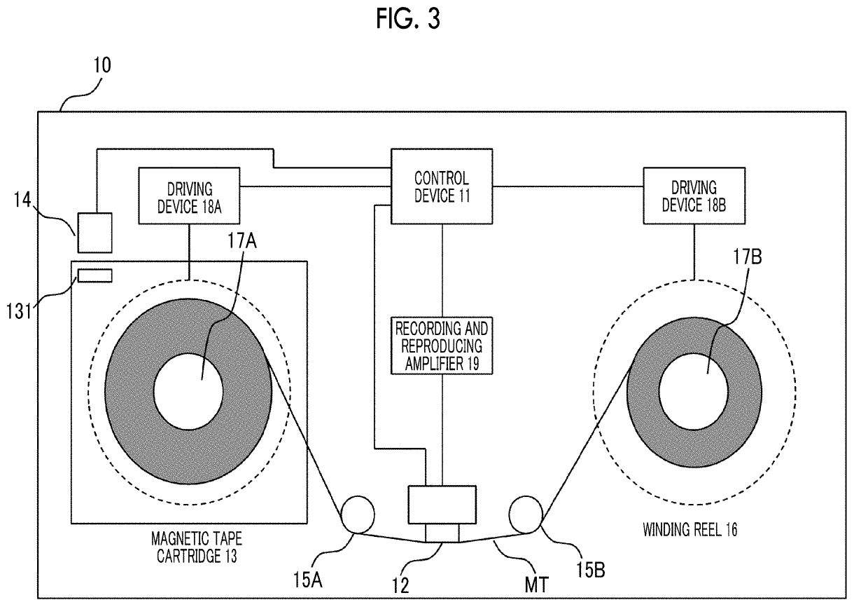

The magnetic tape apparatus may have a tension adjusting mechanism capable of adjusting the tension applied in the longitudinal direction of the magnetic tape running in the magnetic tape apparatus. Such a tension adjusting mechanism can variably control the tension applied in the longitudinal direction of the magnetic tape, and can preferably control the dimension in the width direction of the magnetic tape by adjusting the tension applied in the longitudinal direction of the magnetic tape. In the above tension adjustment, the tension applied in the longitudinal direction of the magnetic tape may change. An example of such a magnetic tape apparatus will be described below with reference to FIG. 3. However, the present invention is not limited to the example shown in FIG. 3.

Configuration of Magnetic Tape Apparatus

A magnetic tape apparatus 10 shown in FIG. 3 controls a recording and reproducing head unit 12 in accordance with an instruction from a control device 11, and records and reproduces data on a magnetic tape MT.

The magnetic tape apparatus 10 has a configuration capable of detecting and adjusting the tension applied in the longitudinal direction of the magnetic tape from spindle motors 17A and 17B for controlling rotation of a magnetic tape cartridge reel and a winding reel and driving devices 18A and 18B thereof.

The magnetic tape apparatus 10 has a configuration capable of loading a magnetic tape cartridge 13.

The magnetic tape apparatus 10 has a cartridge memory reading and writing device 14 capable of reading and writing a cartridge memory 131 in the magnetic tape cartridge 13.

From the magnetic tape cartridge 13 mounted on the magnetic tape apparatus 10, an end portion or a leader pin of the magnetic tape MT is pulled out by an automatic loading mechanism or a manual operation, and the magnetic layer surface of the magnetic tape MT passes on the recording and reproducing head through guide rollers 15A and 15B in a direction contacting with a recording and reproducing head surface of the recording and reproducing head unit 12, and thus the magnetic tape MT is wound around a winding reel 16.

The rotation and torque of the spindle motor 17A and the spindle motor 17B are controlled by a signal from the control device 11, and the magnetic tape MT is run at any speed and tension. A servo pattern previously formed on the magnetic tape can be used to control the tape speed. In order to detect the tension, a tension detecting mechanism may be provided between the magnetic tape cartridge 13 and the winding reel 16. The tension may be controlled by using the guide rollers 15A and 15B in addition to the control by the spindle motors 17A and 17B.

The cartridge memory reading and writing device 14 is configured to be capable of reading out and writing information in the cartridge memory 131 in response to an instruction from the control device 11. As a communication method between the cartridge memory reading and writing device 14 and the cartridge memory 131, for example, an international organization for standardization (ISO) 14443 method can be employed.

The control device 11 includes, for example, a control unit, a storage unit, a communication unit, and the like.

The recording and reproducing head unit 12 includes, for example, a recording and reproducing head, a servo tracking actuator that adjusts a position of the recording and reproducing head in the track width direction, a recording and reproducing amplifier 19, a connector cable for connection with the control device 11, and the like. The recording and reproducing head includes, for example, a recording element for recording data on the magnetic tape, a reproducing element for reproducing data on the magnetic tape, and a servo signal reading element for reading a servo signal recorded on the magnetic tape. For example, one or more recording elements, reproducing elements, and servo signal reading elements are mounted in one magnetic head. Alternatively, each element may be separately provided in a plurality of magnetic heads according to the running direction of the magnetic tape.

The recording and reproducing head unit 12 is configured to be capable of recording data on the magnetic tape MT in response to an instruction from the control device 11. In addition, the recording and reproducing head unit 12 is configured to be capable of reproducing the data recorded on the magnetic tape MT is configured to be able to be reproduced in response to an instruction from the control device 11.

The control device 11 has a mechanism for obtaining the running position of the magnetic tape from the servo signal read from the servo band in a case where the magnetic tape MT is run, and controlling the servo tracking actuator such that the recording element and/or the reproducing element is located at a target running position (track position). The track position is controlled by feedback control, for example. The control device 11 has a mechanism for obtaining a servo band interval from servo signals read from two adjacent servo bands in a case where the magnetic tape MT is run. In addition, the control device 11 has a mechanism for controlling the torque of the spindle motor 17A and the spindle motor 17B and/or the guide rollers 15A and 15B to control the tension in the longitudinal direction of the magnetic tape such that the servo band interval becomes a target value. The tension is controlled by feedback control, for example. In addition, the control device 11 can store the obtained information on the servo band interval in the storage unit inside the control device 11, the cartridge memory 131, an external connection device, or the like.

### EXAMPLES

Hereinafter, the present invention will be described based on Examples. Here, the present invention is not limited to aspects shown in Examples. Unless otherwise noted, “parts” and “%” in the following description indicate “parts by mass” and “mass %”. The processes and evaluations in the following description were performed in an environment of a temperature of 23° C.±1° C., unless otherwise noted. In addition, “eq” described below indicates an equivalent that is a unit that cannot be converted into an SI unit system.

Ferromagnetic Powder

In Table 2, “BaFe” is a hexagonal barium ferrite powder having an average particle size (average plate diameter) of 21 nm.

In Table 2, “SrFe1” is a hexagonal strontium ferrite powder manufactured by the following method.

1707 g of SrCO₃, 687 g of H₃BO₃, 1120 g of Fe₂O₃, 45 g of Al(OH)₃, 24 g of BaCO₃, 13 g of CaCO₃, and 235 g of Nd₂O₃ were weighed and mixed by a mixer to obtain a raw material mixture.

The obtained raw material mixture was melted in a platinum crucible at a melting temperature of 1390° C., and a hot water outlet provided at a bottom of the platinum crucible was heated while stirring a melt, and the melt was discharged in a rod shape at about 6 g/sec.

Hot water was rolled and quenched by a pair of water-cooling rollers to manufacture an amorphous body. 280 g of the manufactured amorphous body was charged into an electric furnace, was heated to 635° C. (crystallization temperature) at a heating rate of 3.5° C./min, and was kept at the same temperature for 5 hours to precipitate (crystallize) hexagonal strontium ferrite particles.

Next, a crystallized product obtained above including hexagonal strontium ferrite particles was coarsely pulverized in a mortar, and 1000 g of zirconia beads having a particle diameter of 1 mm and 800 ml of an acetic acid aqueous solution of 1% concentration were added to the crystallized product in a glass bottle, to be dispersed by a paint shaker for 3 hours. Thereafter, the obtained dispersion liquid was separated from the beads, to be put in a stainless beaker. The dispersion liquid was statically left at a liquid temperature of 100° C. for 3 hours and subjected to a dissolving treatment of a glass component, and then the crystallized product was sedimented by a centrifugal separator to be washed by repeatedly performing decantation and was dried in a heating furnace at an internal temperature of the furnace of 110° C. for 6 hours to obtain a hexagonal strontium ferrite powder.

An average particle size of the hexagonal strontium ferrite powder obtained above was 18 nm, an activation volume was 902 nm³, an anisotropy constant Ku was 2.2×10W J/m³, and a mass magnetization σs was 49 A·m²/kg.

12 mg of a sample powder was taken from the hexagonal strontium ferrite powder obtained above, elemental analysis of the filtrated solution obtained by partially dissolving this sample powder under dissolution conditions illustrated above was performed by an ICP analyzer, and a surface layer portion content of a neodymium atom was determined.

Separately, 12 mg of a sample powder was taken from the hexagonal strontium ferrite powder obtained above, elemental analysis of the filtrated solution obtained by totally dissolving this sample powder under dissolution conditions illustrated above was performed by an ICP analyzer, and a bulk content of a neodymium atom was determined.

A content (bulk content) of a neodymium atom with respect to 100 at % of an iron atom in the hexagonal strontium ferrite powder obtained above was 2.9 at %. A surface layer portion content of a neodymium atom was 8.0 at %. It was confirmed that a ratio between a surface layer portion content and a bulk content, that is, “surface layer portion content/bulk content” was 2.8, and a neodymium atom was unevenly distributed in a surface layer of a particle.

The fact that the powder obtained above shows a crystal structure of hexagonal ferrite was confirmed by performing scanning with CuKα rays under conditions of a voltage of 45 kV and an intensity of 40 mA and measuring an X-ray diffraction pattern under the following conditions (X-ray diffraction analysis). The powder obtained above showed a crystal structure of hexagonal ferrite of a magnetoplumbite type (M type). A crystal phase detected by X-ray diffraction analysis was a single phase of a magnetoplumbite type.

PANalytical X'Pert Pro diffractometer, PIXcel detector

Soller slit of incident beam and diffracted beam: 0.017 radians

Fixed angle of dispersion slit: ¼ degrees

Mask: 10 mm

Anti-scattering slit: ¼ degrees

Measurement mode: continuous

Measurement time per stage: 3 seconds

Measurement speed: 0.017 degrees per second

Measurement step: 0.05 degrees

In Table 2, “SrFe2” is a hexagonal strontium ferrite powder manufactured by the following method.

1725 g of SrCO₃, 666 g of H₃BO₃, 1332 g of Fe₂O₃, 52 g of Al(OH)₃, 34 g of CaCO₃, and 141 g of BaCO₃ were weighed and mixed by a mixer to obtain a raw material mixture.

The obtained raw material mixture was melted in a platinum crucible at a melting temperature of 1380° C., and a hot water outlet provided at a bottom of the platinum crucible was heated while stirring a melt, and the melt was discharged in a rod shape at about 6 g/sec. Hot water was rolled and quenched by a pair of water-cooling rollers to manufacture an amorphous body.

280 g of the obtained amorphous body was charged into an electric furnace, was heated to 645° C. (crystallization temperature), and was kept at the same temperature for 5 hours to precipitate (crystallize) hexagonal strontium ferrite particles.

Next, a crystallized product obtained above including hexagonal strontium ferrite particles was coarsely pulverized in a mortar, and 1000 g of zirconia beads having a particle diameter of 1 mm and 800 ml of an acetic acid aqueous solution of 1% concentration were added to the crystallized product in a glass bottle, to be dispersed by a paint shaker for 3 hours. Thereafter, the obtained dispersion liquid was separated from the beads, to be put in a stainless beaker. The dispersion liquid was statically left at a liquid temperature of 100° C. for 3 hours and subjected to a dissolving treatment of a glass component, and then the crystallized product was sedimented by a centrifugal separator to be washed by repeatedly performing decantation and was dried in a heating furnace at an internal temperature of the furnace of 110° C. for 6 hours to obtain a hexagonal strontium ferrite powder.

An average particle size of the obtained hexagonal strontium ferrite powder was 19 nm, an activation volume was 1102 nm³, an anisotropy constant Ku was 2.0×10W J/m³, and a mass magnetization σs was 50 A·m²/kg.

In Table 2, “ε-iron oxide” is an ε-iron oxide powder manufactured by the following method.

8.3 g of iron(III) nitrate nonahydrate, 1.3 g of gallium(III) nitrate octahydrate, 190 mg of cobalt(II) nitrate hexahydrate, 150 mg of titanium(IV) sulfate, and 1.5 g of polyvinylpyrrolidone (PVP) were dissolved in 90 g of pure water, and while the dissolved product was stirred using a magnetic stirrer, 4.0 g of an aqueous ammonia solution having a concentration of 25% was added to the dissolved product under a condition of an atmosphere temperature of 25° C. in an air atmosphere, and the dissolved product was stirred for 2 hours while maintaining a temperature condition of the atmosphere temperature of 25° C. A citric acid solution obtained by dissolving 1 g of citric acid in 9 g of pure water was added to the obtained solution, and the mixture was stirred for 1 hour. The powder sedimented after stirring was collected by centrifugal separation, was washed with pure water, and was dried in a heating furnace at a furnace temperature of 80° C.

800 g of pure water was added to the dried powder, and the powder was dispersed again in water to obtain dispersion liquid. The obtained dispersion liquid was heated to a liquid temperature of 50° C., and 40 g of an aqueous ammonia solution having a concentration of 25% was dropwise added with stirring. After stirring for 1 hour while maintaining the temperature at 50° C., 14 mL of tetraethoxysilane (TEOS) was dropwise added and was stirred for 24 hours. A powder sedimented by adding 50 g of ammonium sulfate to the obtained reaction solution was collected by centrifugal separation, was washed with pure water, and was dried in a heating furnace at a furnace temperature of 80° C. for 24 hours to obtain a ferromagnetic powder precursor.

The obtained ferromagnetic powder precursor was loaded into a heating furnace at a furnace temperature of 1000° C. in an air atmosphere and was heat-treated for 4 hours.

The heat-treated ferromagnetic powder precursor was put into an aqueous solution of 4 mol/L sodium hydroxide (NaOH), and the liquid temperature was maintained at 70° C. and was stirred for 24 hours, whereby a silicic acid compound as an impurity was removed from the heat-treated ferromagnetic powder precursor.

Thereafter, the ferromagnetic powder from which the silicic acid compound was removed was collected by centrifugal separation, and was washed with pure water to obtain a ferromagnetic powder.

The composition of the obtained ferromagnetic powder that was checked by high-frequency inductively coupled plasma-optical emission spectrometry (ICP-OES) has Ga, Co, and a Ti substitution type ε-iron oxide (ε-Ga_{0.28}Co_{0.05}Ti_{0.05}Fe_{1.62}O₃). In addition, X-ray diffraction analysis is performed under the same condition as that described above for SrFe1, and from a peak of an X-ray diffraction pattern, it was confirmed that the obtained ferromagnetic powder does not include α-phase and γ-phase crystal structures, and has a single-phase and ε-phase crystal structure (ε-iron oxide type crystal structure).

The obtained ε-iron oxide powder had an average particle size of 12 nm, an activation volume of 746 nm³, an anisotropy constant Ku of 1.2×10⁵ J/m³, and a mass magnetization as of 16 A·m²/kg.

An activation volume and an anisotropy constant Ku of the above hexagonal strontium ferrite powder and ε-iron oxide powder are values obtained by the method described above using a vibrating sample magnetometer (manufactured by Toei Industry Co., Ltd.) for each ferromagnetic powder.

In addition, a mass magnetization σs is a value measured at a magnetic field intensity of 15 kOe using a vibrating sample magnetometer (manufactured by Toei Industry Co., Ltd.).

Preparation of Abrasive Liquid

Preparation of Abrasive Liquid A

2,3-dihydroxynaphthalene (manufactured by Tokyo Chemical Industry Co., Ltd.) having the amount shown in Table 1, 31.3 parts of a 32% solution (solvent is a mixed solvent of methyl ethyl ketone and toluene) of a polyester polyurethane resin having a SO₃Na group as a polar group (UR-4800 manufactured by Toyobo Co., Ltd. (amount of a polar group: 80 meq/kg)), and 570.0 parts of a mixed liquid of methyl ethyl ketone and cyclohexanone at 1:1 (mass ratio) as a solvent were mixed with respect to 100.0 parts of the abrasive (alumina powder) shown in Table 1, and dispersed in the presence of zirconia beads (bead diameter: 0.1 mm) by a paint shaker for the time (beads dispersion time) shown in Table 1.

After the dispersion, the dispersion liquid obtained by separating the dispersion liquid and the beads with a mesh was subjected to centrifugal separation. The centrifugal separation was carried out using CS150GXL manufactured by Koki Holdings Co., Ltd. (the rotor used is S100AT6 manufactured by Koki Holdings Co., Ltd.) as a centrifugal separator at the rotation speed (rotation per minute (rpm)) shown in Table 1 for the time (centrifugal separation time) shown in Table 1. By this centrifugal separation, particles having a relatively large particle size were sedimented, and particles having a relatively small particle size were dispersed in a supernatant.

After that, the supernatant was collected by decantation. This collected liquid is called an “abrasive liquid A”.

Preparation of Abrasive Liquids B and C

An abrasive liquid B and an abrasive liquid C were prepared in the same manner as in the preparation of the abrasive liquid A except that various items were changed as shown in Table 1.

TABLE 1

| | | | Abrasive liquid A | | Abrasive liquid B | | Abrasive liquid C | |
|---|---|---|---|---|---|---|---|---|
| Preparation | Product name of abrasive | | Hit 80 | | Hit 70 | | Hit 70 | |
| of abrasive | (manufactured by Sumitomo | | | | | | | |
| liquid | Chemical Co., Ltd.) | | | | | | | |
| | BET specific surface area | | 30 | | 20 | | 20 | |
| | of abrasive (m²/g) | | | | | | | |
| | Content of abrasive liquid | | 3 | times | 3 | times | 0 | times |
| | dispersing agent | | | | | | | |
| | (2,3-dihydroxynaphthalene) | | | | | | | |
| | Beads dispersion time | | 360 | minutes | 180 | minutes | 60 | minutes |
| | Centrifugal | Rotation speed | 5500 | rpm | 3500 | rpm | 1000 | rpm |
| | separation | Centrifugal | 4 | minutes | 4 | minutes | 4 | minutes |
| | | separation time | | | | | | |

### Example 1

Preparation of Magnetic Layer Forming Composition
Magnetic Liquid
Ferromagnetic powder (see Table 2): 100.0 parts
Oleic acid: 2.0 parts
Vinyl chloride copolymer (MR-104 manufactured by Zeon Corporation): 10.0 parts
SO₃Na group-containing polyurethane resin: 4.0 parts (weight-average molecular weight: 70000, SO₃Na group: 0.07 meq/g)
Polyalkyleneimine polymer (synthetic product obtained by the method disclosed in paragraphs 0115 to 0123 of JP2016-51493A): 6.0 parts
Methyl ethyl ketone: 150.0 parts
Cyclohexanone: 150.0 parts
Abrasive Liquid
Use the abrasive liquid shown in Table 2 such that the amount of abrasive in the abrasive liquid is the amount shown in Table 2
Other Components
Carbon black (average particle size: 20 nm): 0.7 parts
Polyethyleneimine (manufactured by Nippon Shokubai Co., Ltd., number-average molecular weight of 300): 2.0 parts
Stearic acid: 0.5 parts
Stearic acid amide: 0.3 parts
Butyl stearate: 6.0 parts
Methyl ethyl ketone: 110.0 parts
Cyclohexanone: 110.0 parts
Polyisocyanate (CORONATE (registered trademark) L manufactured by Tosoh Corporation): 3.0 parts

Preparation Method

Various components of the above magnetic liquid were dispersed using zirconia beads (first dispersion beads, density of 6.0 g/cm³) having a bead diameter of 0.5 mm by a batch type vertical sand mill for 24 hours (first stage), and then filtered using a filter having a pore diameter of 0.5 μm. Thereby, a dispersion liquid A was prepared. The zirconia beads were used in an amount of 10 times the mass of the ferromagnetic powder on a mass basis.

After that, the dispersion liquid A was dispersed using diamond beads (second dispersion beads, density of 3.5 g/cm³) having a bead diameter of 500 nm by a batch type vertical sand mill for 1 hour (second stage), and a dispersion liquid (dispersion liquid B) in which the diamond beads were separated using a centrifugal separator was prepared. The diamond beads were used in an amount of 10 times the mass of the ferromagnetic powder on a mass basis.

The dispersion liquid B, the abrasive liquid, and the other components described above were put into a dissolver stirrer, and stirred for 360 minutes at a circumferential speed of 10 m/sec. After that, an ultrasonic dispersion treatment was performed at a flow rate of 7.5 kg/min for 60 minutes by a flow type ultrasonic dispersing device, and then the obtained liquid was filtered three times through a filter having a pore diameter of 0.3 μm. Thereby, a magnetic layer forming composition was prepared.

Preparation of Non-Magnetic Layer Forming Composition Various components of the following non-magnetic layer forming composition were dispersed using zirconia beads having a bead diameter of 0.1 mm by a batch type vertical sand mill for 24 hours, and then filtered using a filter having a pore diameter of 0.5 μm. Thereby, the non-magnetic layer forming composition was prepared.

Non-magnetic inorganic powder α-Iron oxide: 100.0 parts
(average particle size: 10 nm, BET specific surface area: 75 m²/g)

Carbon black: 25.0 parts
(average particle size: 20 nm)

SO₃Na group-containing polyurethane resin: 18.0 parts
(weight-average molecular weight: 70,000, SO₃Na group content: 0.2 meq/g)

Stearic acid: 1.0 part

Cyclohexanone: 300.0 parts

Methyl ethyl ketone: 300.0 parts

Preparation of Back Coating Layer Forming Composition

Components other than a lubricant (stearic acid and butyl stearate), polyisocyanate, and 200.0 parts of cyclohexanone among various components of the following back coating layer forming composition were kneaded and diluted by an open kneader, and then subjected to a dispersion treatment of 12 passes using a horizontal beads mill dispersing device and zirconia beads having a bead diameter of 1 mm, by setting a bead filling rate to 80 volume %, a circumferential speed of a rotor distal end to 10 m/sec, and a retention time per 1 pass to 2 minutes. After that, the remaining components were added thereto and stirred by a dissolver, and the obtained dispersion liquid was filtered using a filter having a pore diameter of 1 μm. Thereby, a back coating layer forming composition was prepared.

Non-magnetic inorganic powder α-iron oxide: 80.0 parts
(average particle size: 0.15 μm, BET specific surface area: 52 m²/g)

Carbon black: 20.0 parts
(average particle size: 20 nm)

Vinyl chloride copolymer: 13.0 parts

Sulfonic acid base-containing polyurethane resin: 6.0 parts

Phenylphosphonic acid: 3.0 parts

Cyclohexanone: 155.0 parts

Methyl ethyl ketone: 155.0 parts

Stearic acid: 3.0 parts

Butyl stearate: 3.0 parts

Polyisocyanate: 5.0 parts

Cyclohexanone: 200.0 parts

Manufacturing of Magnetic Tape and Magnetic Tape Cartridge

The non-magnetic layer forming composition prepared in the above section was applied onto a surface of a polyethylene naphthalate support having a thickness of 4.1 μm and was dried so that the thickness after drying is a thickness of 0.7 μm, and thus a non-magnetic layer was formed.

Next, the magnetic layer forming composition prepared in the above section was applied onto the non-magnetic layer so that the thickness after drying is 0.1 μm, and thus a coating layer was formed.

After that, while this coating layer of the magnetic layer forming composition is in a wet state, a vertical orientation treatment was performed by applying a magnetic field of a magnetic field intensity of 0.3 T in a direction perpendicular to a surface of the coating layer, and then the surface of the coating layer was dried. Thereby, a magnetic layer was formed.

After that, the back coating layer forming composition prepared in the above section was applied onto a surface of the support opposite to the surface on which the non-magnetic layer and the magnetic layer are formed and was dried so that the thickness after drying is 0.3 μm, and thus, a back coating layer was formed.

After that, a surface smoothing treatment (calendering treatment) was performed using a calendar roll formed of only metal rolls at a speed of 100 m/min, a linear pressure of 300 kg/cm, and a calendar temperature of 90° C. (surface temperature of calendar roll). In this way, a long magnetic tape original roll was obtained.

After that, a heat treatment was performed for 36 hours in an environment of an atmosphere temperature of 70° C., and then a long magnetic tape original roll was slit to have ½ inches width to obtain a magnetic tape.

A servo signal was recorded on the magnetic layer of the obtained magnetic tape by a commercially available servo writer to obtain a magnetic tape having a data band, a servo band, and a guide band in an arrangement according to a linear tape-open (LTO) Ultrium format and having a servo pattern (timing-based servo pattern) in an arrangement and a shape according to the LTO Ultrium format on the servo band. The servo pattern thus formed is a servo pattern according to the description in Japanese industrial standards (JIS) X6175:2006 and Standard ECMA-319 (June 2001). The total number of servo bands is 5, and the total number of data bands is 4.

The magnetic tape (length of 960 m) on which the servo signal is recorded was wound around a reel of a magnetic tape cartridge (LTO Ultrium 8 data cartridge).

In this way, the magnetic tape cartridge of Example 1 in which the magnetic tape was wound on a reel was manufactured.

It could be confirmed by the following method that the magnetic layer of the magnetic tape includes a compound formed of polyethyleneimine and stearic acid and including the ammonium salt structure of the alkyl ester anion represented by Formula 1.

A sample was cut out from the magnetic tape, and X-ray photoelectron spectroscopy analysis is performed on the magnetic layer surface (measurement area: 300 μm×700 μm) using an ESCA device. Specifically, the wide scanning measurement was performed by the ESCA device under the following measurement conditions. In measurement results, peaks were confirmed at a binding energy position of an ester anion and a binding energy position of an ammonium cation.

Device: AXIS-ULTRA manufactured by Shimadzu Corporation

Excited X-ray source: monochromatic Al-Ku ray

Scanning range: 0 to 1,200 eV

Pass energy: 160 eV

Energy resolution: 1 eV/step

Take-in time: 100 ms/step

Accumulation number: 5

In addition, a sample piece having a length of 3 cm was cut out from the magnetic tape, and the attenuated total reflection-fourier transform-infrared spectrometer (ATR-FT-IR) measurement (reflection method) was performed on the magnetic layer surface. In measurement results, an absorption was confirmed at the wave number (1540 cm⁻¹ or 1430 cm⁻¹) corresponding to an absorption of COO⁻ and the wave number (2400 cm⁻¹) corresponding to an absorption of an ammonium cation.

### Examples 2 to 14 and Comparative Examples 1 to 13

A magnetic tape and a magnetic tape cartridge were obtained by the same method as in Example 1 except that the items shown in Table 2 were changed as shown in Table 2.

For each of the examples and comparative examples, two magnetic tape cartridges were prepared, one for evaluation of the following deterioration of the electromagnetic conversion characteristics and the other for evaluation of the following magnetic tape.

Evaluation of Deterioration of Electromagnetic Conversion Characteristics (Signal-to-Noise-Ratio (SNR) Decrease Amount)

The SNR decrease amount was obtained as an evaluation of the deterioration of the electromagnetic conversion characteristics by the following method. The following recording and reproduction were performed using a reel tester having ½ inches with a fixed magnetic head.

For each magnetic tape (total length of magnetic tape: 960 m) of Examples and Comparative Examples, in an environment of a temperature of 23° C. and a relative humidity of 50%, 1000 passes of recording and reproduction were performed by applying a tension of 1.5 N (hereinafter, referred to as a “running tension”) in the longitudinal direction of the magnetic tape, and then 1000 passes of recording and reproduction were performed by applying a tension of 0.2 N in the longitudinal direction of the magnetic tape. A relative speed between the magnetic tape and the magnetic head was set to 8 m/sec, and recording was performed by using a metal-in-gap (MIG) head (a gap length of 0.15 μm and a track width of 1.0 μm) as a recording head and setting a recording current to an optimal recording current of each magnetic tape. Reproduction was performed by using a giant-magnetoresistive (GMR) head (an element thickness of 15 nm, a shield interval of 0.1 μm, and a reproducing element width of 0.8 μm) as a reproducing head. A signal having a linear recording density of 300 kfci was recorded, and measurement regarding a reproduction signal was performed with a spectrum analyzer manufactured by Shibasoku Co., Ltd. The unit kfci is a unit of a linear recording density (cannot be converted into an SI unit system). As the signal, a portion where the signal was sufficiently stable after start of the running of the magnetic tape was used.

A difference between the SNR of the first pass at the running tension of 1.5 N and the SNR of the 1000th pass at the running tension of 0.2 N (SNR of the 1000th pass at the running tension of 0.2 N-SNR of the first pass at the running tension of 1.5 N) was calculated and used as the SNR decrease amount.

Evaluation of Magnetic Tape

(1) AlFeSil Abrasion Value_{0.2 N} and AlFeSil Abrasion Value_{1.5 N}

The magnetic tape was taken out from each magnetic tape cartridge of Examples and Comparative Examples, and in an environment of a temperature of 23° C. and a relative humidity of 50%, the AlFeSil abrasion value_{0.2 N} and the AlFeSil abrasion value_{1.5 N} were obtained by the method described above.

(2) Tape Thickness

10 tape samples (length of 5 cm) were cut out from any part of the magnetic tape taken out from each magnetic tape cartridge of Examples and Comparative Examples, and the thickness was measured by stacking these tape samples. The thickness was measured using a digital thickness gauge of Millimar 1240 compact amplifier and Millimar 1301 induction probe manufactured by Mahr Inc. A value (thickness per tape sample) obtained by dividing the measured thickness by 1/10 was defined as the tape thickness. Each magnetic tape had a thickness of 5.2 μm.

The above results are shown in Table 2.

TABLE 2

| | Magnetic layer forming composition | | | | | | | | |
|---|---|---|---|---|---|---|---|---|---|
| | | | Stearic acid | | | | | | |
| | Ferromagnetic | Polyethyleneimine | Presence or | | | | | | SNR decrease |
| | powder | Presence or absence | absence of | Abrasive liquid | | | AlFeSil abrasion | AlFeSil abrasion | amount |
| | Type | of addition | addition | A | B | C | value_{0.2 N} | value_{1.5 N} | (dB) |
| Example 1 | BaFe | Addition | Addition | 6.0 | 3.0 | 1.0 | 28 μm | 43 μm | 0.6 |
| Example 2 | BaFe | Addition | Addition | 4.0 | 3.0 | 1.0 | 25 μm | 35 μm | 0.8 |
| Example 3 | BaFe | Addition | Addition | 3.0 | 3.0 | 1.0 | 23 μm | 31 μm | 0.9 |
| Example 4 | BaFe | Addition | Addition | 6.0 | 4.0 | 1.0 | 32 μm | 48 μm | 0.8 |
| Example 5 | BaFe | Addition | Addition | 6.0 | 2.0 | 1.0 | 25 μm | 39 μm | 0.6 |
| Example 6 | BaFe | Addition | Addition | 6.0 | 3.0 | 2.0 | 35 μm | 48 μm | 0.8 |
| Example 7 | BaFe | Addition | Addition | 3.0 | 5.0 | 3.5 | 43 μm | 49 μm | 0.9 |
| Example 8 | BaFe | Addition | Addition | 9.5 | 1.0 | 0.5 | 24 μm | 47 μm | 0.7 |
| Example 9 | BaFe | Addition | Addition | 3.0 | 1.5 | 1.5 | 21 μm | 26 μm | 0.8 |
| Example 10 | BaFe | Addition | Addition | 4.0 | 2.0 | 2.5 | 32 μm | 37 μm | 0.4 |
| Example 11 | BaFe | Addition | Addition | 4.0 | 3.5 | 2.5 | 37 μm | 43 μm | 0.5 |
| Example 12 | SrFe1 | Addition | Addition | 6.0 | 3.0 | 1.0 | 27 μm | 42 μm | 0.6 |
| Example 13 | SrFe2 | Addition | Addition | 6.0 | 3.0 | 1.0 | 28 μm | 42 μm | 0.6 |
| Example 14 | ε-Iron oxide | Addition | Addition | 6.0 | 3.0 | 1.0 | 29 μm | 43 μm | 0.6 |
| Comparative Example 1 | BaFe | None | Addition | 7.0 | 4.0 | 3.0 | 25 μm | 60 μm | 1.5 |
| Comparative Example 2 | BaFe | None | Addition | 6.0 | 3.0 | 1.0 | 20 μm | 51 μm | 1.4 |
| Comparative Example 3 | BaFe | None | Addition | 4.0 | 3.0 | 1.0 | 18 μm | 47 μm | 1.6 |
| Comparative Example 4 | BaFe | None | Addition | 3.0 | 3.0 | 1.0 | 18 μm | 44 μm | 1.5 |
| Comparative Example 5 | BaFe | None | Addition | 6.0 | 4.0 | 1.0 | 22 μm | 55 μm | 1.6 |
| Comparative Example 6 | BaFe | None | Addition | 6.0 | 2.0 | 1.0 | 18 μm | 47 μm | 1.6 |
| Comparative Example 7 | BaFe | None | Addition | 6.0 | 3.0 | 2.0 | 24 μm | 60 μm | 1.5 |
| Comparative Example 8 | BaFe | None | Addition | 6.0 | 3.0 | 0.5 | 18 μm | 47 μm | 1.6 |
| Comparative Example 9 | BaFe | None | Addition | 0.0 | 0.0 | 3.0 | 12 μm | 24 μm | 1.9 |
| Comparative Example 10 | BaFe | None | Addition | 0.0 | 0.0 | 5.0 | 24 μm | 59 μm | 1.7 |
| Comparative Example 11 | BaFe | None | Addition | 0.0 | 0.0 | 10.0 | 52 μm | 80 μm | 2.2 |
| Comparative Example 12 | BaFe | Addition | Addition | 7.0 | 4.0 | 3.0 | 48 μm | 61 μm | 1.5 |
| Comparative Example 13 | BaFe | Addition | Addition | 1.0 | 0.5 | 0.0 | 11 μm | 18 μm | 2.1 |

As shown in Table 2, in the magnetic tape of Examples in which both the AlFeSil abrasion value_{0.2 N} and the AlFeSil abrasion value_{1.5 N} are in the ranges described above, the decrease amount of the electromagnetic conversion characteristics measured by changing the running tension was smaller than that of the magnetic tape of Comparative Examples. From the above results, it can be said that the magnetic tape of Examples is a magnetic tape capable of suppressing the deterioration of the electromagnetic conversion characteristics in a magnetic tape apparatus that controls the dimension in the width direction of the magnetic tape by adjusting the tension applied in the longitudinal direction of the magnetic tape.

An aspect of the present invention is useful in various data storage technical fields.

What is claimed is:

1. A magnetic tape comprising:
a non-magnetic support; and
a magnetic layer including a ferromagnetic powder,
wherein in an environment of a temperature of 23° C. and a relative humidity of 50%,
an AlFeSil abrasion value_{0.2 N} on a magnetic layer surface, which is measured by applying a tension of 0.2 N in a longitudinal direction of the magnetic tape, is in a range of 20 to 50 μm, and
an AlFeSil abrasion value_{1.5 N} on the magnetic layer surface, which is measured by applying a tension of 1.5 N in the longitudinal direction of the magnetic tape, is in a range of 20 to 50 μm.

2. The magnetic tape according to claim 1,
wherein the AlFeSil abrasion value_{0.2 N} is in a range of 20 to 45 μm.

3. The magnetic tape according to claim 1,
wherein the AlFeSil abrasion value_{1.5 N} is in a range of 30 to 50 μm.

4. The magnetic tape according to claim 2,
wherein the AlFeSil abrasion value_{1.5 N} is in a range of 30 to 50 μm.

5. The magnetic tape according to claim 1,
wherein the magnetic layer includes one or more non-magnetic powders.

6. The magnetic tape according to claim 5,
wherein the non-magnetic powder includes an alumina powder.

7. The magnetic tape according to claim 1, further comprising:
a non-magnetic layer including a non-magnetic powder between the non-magnetic support and the magnetic layer.

8. The magnetic tape according to claim 1, further comprising:
a back coating layer including a non-magnetic powder on a surface side of the non-magnetic support opposite to a surface side having the magnetic layer.

9. The magnetic tape according claim 1,
wherein a tape thickness is 5.2 μm or less.

10. A magnetic tape cartridge comprising:
the magnetic tape according to claim 1.

11. A magnetic tape apparatus comprising:
the magnetic tape according to claim 1.

12. The magnetic tape apparatus according to claim 11, further comprising:
a tension adjusting mechanism capable of adjusting the tension applied in the longitudinal direction of the magnetic tape running in the magnetic tape apparatus.

13. The magnetic tape apparatus according to claim 11, further comprising:
a magnetic head having a reproducing element width of 0.8 μm or less.

14. The magnetic tape apparatus according to claim 12, further comprising:
a magnetic head having a reproducing element width of 0.8 μm or less.
